(19) United States
(12) Patent Application Publication
(10) Pub. No.: US 2005/0141706 A1
(43) Pub. Date: Jun. 30, 2005

(54) System and method for secure ad hoc mobile communications and applications

(76) Inventors: William C. Regli, Philadelphia, PA (US); Moshe Kam, Philadelphia, PA (US)

Correspondence Address: Robert F. Zielinski, Esquire;Wolf, Block, Schorr & Solis-Cohen LLP, 22nd Floor, 1650 Arch Street, Philadelphia, PA, 19103-2097, US

(21) Appl. No.: 11/025,314

(22) Filed: Dec. 29, 2004

Related U.S. Application Data
(60) Provisional application No. 60/533,561, filed on Dec. 31, 2003.

(51) Int. Cl. H04L 9/00

(52) U.S. Cl. 380/44; 713/151

(57) ABSTRACT

A mobile agent system bridges applications and communications with next generation wireless and mobile ad hoc network infrastructures. A method utilizing middleware turns traditional applications and communications into network centric applications. Agent-based systems are used as a wrapper of existing legacy applications (or new applications that are network naive) and build methods of creating network aware agents. The network aware agents can adapt applications and communications to the changing network dynamics. An algorithmic technique divides private keys into multiple subkeys and distributes them to different nodes on a MANET using mobile agents. The mobile agents react to network dynamics to ensure that all of the requisite key components are kept within a suitable network distance from the host that owns them. Mobile agents can dynamically plan their information delivery routes to optimize any number of criteria: bandwidth impact, time, power, etc.

### CROSS-REFERENCE TO RELATED APPLICATION

This application claims the benefit of U.S. Provisional Application No. 60/533,561, filed Dec. 31, 2003, the entire disclosure of which is incorporated herein by reference.

### FIELD

This invention relates in general to the field of communications and, more particularly, to an improved system and method for secure communications and secure applications.

### BACKGROUND

Security is the state of a system where the risk to all assets has been minimized to an acceptable level. Security engineering is the practice of addressing the protection needs of all assets in a system. In security engineering, one can only minimize risk, not eliminate it.

A mobile agent is a self-contained program that can dynamically traverse a network on its own accord, possibly acting on behalf of a user or another party. In an ad hoc network, any host in the network may serve as a router for any other host in the network. In this way, the host in an ad hoc network can dynamically fulfill the role of a router, thus enabling it to adapt in real time to changes in network topology—leading to network dynamism that can significantly influence the behavior of an agent system or any application.

Security should be a major concern in the development of a mobile agent system or any system. A mobile agent may encounter a malicious host. A host may receive a malicious agent. Malicious agents, or hosts, may try to eavesdrop on communication between agents, hosts, or between an agent and host. If an ad hoc wireless network is considered, additional concerns arise. A host can physically be hijacked. Highly mobile hosts may go online or offline unexpectedly, necessitating determination of new network routes. Agents/hosts may need to consider suspected malicious hosts in determining a network route.

Despite the importance of security for mobile agent systems, the majority of work on mobile agent systems does not take into consideration security concerns. Few agent architectures focus on issues of security. The designers of an agent system often assume the security of their system is a concern for someone else working at the network level. The majority of work that has been done specifically for mobile agent security has been on security mechanisms. Very little has been done integrating security into agent systems during the development process—analyzing the assets and potential threats specific to the given agent system and developing mechanisms to address those threats in light of a chosen security policy.

Comprehensive security engineering requires that all principals and channels be considered at all layers of a given system. If any principal or channel is ignored, then not all of the threats to information needing protection have been considered.

In any system, information can be thought of as being either at rest on in motion. Data at rest is simply data in storage. The registers of a CPU, the cache on a hard drive, and the human brain are all examples of places where data can be stored. Data in motion is data moving between two units of storage. Wireless network traffic, a bus connecting a CPU and memory and a human typing on a keyboard are all examples of data in motion. The term “principal” is used to mean a place where data can be at rest. The term “channel” is used to refer to a place where data can be in motion. A “path” is the sequence of principals and channels through which data flows.

The principals and channels are abstract units that describe a system independent of implementation details. However, in security engineering, the implementation details are critical in determining how principals and channels may be attacked. A point or channel may exist across many layers of implementation; thus one must consider all layers of hardware and software implementation in which these principals and channels exist. A “layer” is a unit of hardware or abstraction of hardware or software where one can identify principals and channels with the implementation of a system. The OSI Reference Model (OSI-RM) for computer networks is an example of a set of layers. Each layer in the OSI-RM has a unique set of principals and channels. Even though each layer may be referring to the same perceived principals and channels, the principals and channels in each layer are working with some unique data. All places where data may exist can be described in terms of principals, channels, and layers.

The ordering of data sent between two principals is determined by a “protocol.” A protocol consists of rules that determine how, when, and what data is sent between two principals over a channel. It is not uncommon for two principals to have a restricted type of information that may be transferred between them (e.g., a bank will only provide a customer with information about that customer's accounts). A protocol facilitates this restricted flow of information, and thus an attack on the protocol may be a threat to the information at the principals or in the channel between them.

In any given computing system, there are “assets,” “actors,” “threats,” and “outcomes.” The security needs of a system are identified in terms of these features.

An asset is an entity that is or will be worth protecting. A security engineer considers not just the location of an asset (a principal), but also the means and medium by which an asset is moved (a channel). A security mechanism may protect an asset, but it can fail to protect information about that asset.

An actor is an entity that can act within one or more layers of a system. More specifically, an actor is an entity with the potential to enact a threat against an asset. While an actor may be traced back to a human, the actors within a given layer may not be human. Through the determination of the actors, it becomes known who or what must be restricted in order to minimize the risk of a related threat.

A threat represents how an undesirable event could occur. Once the assets and actors in a given layer are understood, it is possible to determine what threats the actors pose to the assets. In most cases, it is impossible and impractical to eliminate all possible threats. Instead, it is important to carefully consider the set of all possible threats, and to address only the most significant ones.

An outcome is an undesirable result caused by an actor in a system. There are many ideas on categories of outcomes in security literature. One general set of outcomes is described in the OCTAVE threat profiling system (Octave: Information security risk evaluation (2002)). These categories generally describe the types of outcomes that apply to all assets in a system:

1. Disclosure: information in the asset is released to an unintended recipient.

2. Loss: information is irretrievably lost from within the asset.

3. Modification: information within the asset is modified.

4. Interruption: channels to and from the asset are made unusable.

While there is a vast community studying agent technologies, little work exists on how to effectively integrate mobile agents, ad hoc networking and practical information assurance technologies. For example, while mobile agents have been used for discovering routes in ad hoc networks (Bandyopadhyay & Paul 1999), little has been published regarding how agent systems can be designed to positively exploit the features of an ad hoc network. Agent security research has usually addressed how agents' representation and reasoning about concepts such as “trust” among agents, or agents' beliefs, desires and intentions (Subrahmanian et al. 2000). Little exists on how to integrate mobile agents with a cryptographic infrastructure and how to adapt centralized security techniques to peer-to-peer networks.

There are currently many different approaches to and implementations of mobile agent architectures (Cohen et al. 1997; Gray et al. 2001; Hoile et al. 2002; Jennings, Sycara, & Wooldridge 1998; Sadeh et al. 1999; Sycara et al. 2001). One such architecture is the Extendable Mobile Agent Architecture (EMAA) from Lockheed Martin's Advanced Technology Laboratories (http://www.atl.lmco.com). The EMAA framework includes autonomous and asynchronous agents as well as management mechanisms for agent mobility, agent events and inter-agent communication (Lentini et al. 1998). Architecturally, EMAA is composed of three core layers: Docks, Servers, and Agents. Docks provide the execution environment on a host in which all other components are executed. Servers provide “heavy-weight” or fixed services while Agents are “lighter” and mobile, each having task lists and itineraries. While highly autonomous, EMAA agents can still receive and respond to commands from a controlling authority, thus balancing between totally autonomous behavior and cooperation to command centers that may be controlled by human users (McCormick et al. 1999).

In addition to agent messaging and agent migration, EMAA also supports event messaging. The Distributed Event Messaging System (DEMS) is an integral part of EMAA responsible for all event-based communications within the framework. EMAA utilizes DEMS because traditional systems like CORBA and RMI use static bindings to locate and communicate with agents, and since EMAA's agents are mobile their location changes from time to time (McCormick et al. 1999). DEMS was created to follow the Java Event model; event messages themselves are delivered by Transmission Agents.

A mobile ad hoc network (“MANET”) is composed of hosts, where each host corresponds to a physical network device. If two hosts have a direct connection, a link exists between these hosts. Moreover, any two hosts with a link between them are called neighbors. A host can only communicate directly with its neighbors. The purpose of an ad hoc routing protocol is to enable hosts without a link between them to communicate. Hosts that are not neighbors can use other hosts in the network to form a continuous path of links through which they communicate. This path is referred to as a route between the two hosts. The procedure used to choose routes is called a routing protocol.

There are currently more than 50 published routing protocols, each claiming to out-perform the others in some regard. In general, a MANET routing protocol is either on-demand or proactive. An on-demand protocol locates routes as they are needed, resulting in a possible delay each time a new route is established. A proactive protocol continuously updates routing information, but does so at the cost of increased network traffic over on-demand techniques. AODV, TORA, and DSR are non-limiting examples of on-demand protocols. DSDV, OLSR, and TBRPF are non-limiting examples of proactive protocols. ZRP is a compromise between proactive and on-demand, where only small parts of the network are proactively updated, and a hierarchy is used to interconnect these parts. None of these consider security as part of their design. SEAD is a proactive protocol with security, but does not have global information or considerations for efficient representation and information assurance. Moreover, SEAD does not provide complete confidentiality for routing information transmitted as part of the protocol.

An agent system comprises agents located on one or more physical hosts connected via a network. The hosts in a wireless, ad hoc network may be capable of being physically moved while in operation (e.g., PDAs). Each time a host is moved, the network topology may change to maintain connectivity. If a host cannot send a message directly to another host, then messages are routed through other hosts. Each host provides an execution environment for one or more agents, and the underlying physical network provides the means for agents on different hosts to communicate and migrate.

Given the plethora of new techniques for identifying network intruders, the compromised host problem has been examined, e.g., determining the appropriate response to an identified intruder. In the context of a mobile, multi-agent system operating on an ad hoc network, it is not merely a simple matter of removing the compromised hosts and its agents. While keeping the compromised host can result in information disclosure, removal of the host can degrade or even sever the network. An agent system and an introduction of a measure of information assurance for the system in terms of the integrity of the messages delivered to the agents in a given network state is needed.

### SUMMARY

In accordance with one aspect of the present invention, a method of developing and deploying an application or communication on a computer network comprises building a key through use of a contributory group key generating algorithm in conjunction with a key agreement protocol, employing a messaging system for running the key agreement protocol and using a mechanism for revoking the key from an agent, user, group, network or host.

In accordance with another aspect of the invention, a system for developing and deploying an application or communication on a computer network comprises a contributory group key generating algorithm in conjunction with a key agreement protocol for building a key, a messaging system for running the key agreement protocol and a mechanism for revoking the key from an agent, user, group, network or host.

In accordance with yet another aspect of the invention, a system for developing and deploying a distributed application or communication on a dynamically changing computer network comprises a mechanism for deploying a mobile software agent with a rate of migration on at least one network, and a mobile node.

In accordance with still another aspect of the invention, a method for developing and deploying a distributed application or communication on a dynamically changing computer network comprises deploying a mobile software agent with a rate of migration on at least one network and temporarily holding software code in a mobile node.

### BRIEF DESCRIPTION OF THE DRAWINGS

In the drawings, which are discussed below, one or more preferred embodiments are illustrated, with the same reference numerals referring to the same pieces of the invention throughout the drawings. It is understood that the invention is not limited to the preferred embodiments depicted in the drawings herein, but rather it is defined by the claims appended hereto and equivalent structures.

FIG. 1 shows a conceptual view of SWAT and some of its features.

FIG. 2 shows a flow chart of a SWAT network architecture.

FIG. 3 shows a flow chart of a SWAT host architecture.

FIG. 4 shows a flow chart of a tree notation, wherein the tree notation and path from <3,3> to root is shown in bold.

FIG. 5 shows a SWAT system block diagram.

FIG. 6 shows an agent system and its two distinct layers of communication.

FIG. 7 shows a functional diagram a SWAT network of PDAs and a SEM.

FIG. 8 shows a chart of TGDH “Join” and “LEAVE” operations on a network of desktops with Secure Spread and with Secure Spread and EMAA.

FIG. 9 shows a chart of TGDH “Join” and “Leave” operations on a network of PDAS with Secure Spread and with Secure Spread and EMAA.

FIG. 10 shows a chart of GDH “Join” and “Leave” operations on a network of desktops with Secure Spread and with Secure Spread and EMAA.

FIG. 11 shows a chart of GDH “Join” and “Leave” operations on a network of PDAs with Secure Spread and with Secure Spread and EMAA.

FIG. 12 shows a chart of TGDH “Join” and “Leave” operations with and without the SEM on a network of desktops.

FIG. 13 shows an initial host topology for a SWAT.

FIG. 14 shows routes to heartbeat monitor h₁.

FIG. 15 shows routes from cameras h₁ and h₅.

FIG. 16 shows a flow chart of bid propagation to host h₁ in a Vickrey auction.

FIG. 17 shows a diagram of the group “A” with unit 1 as a member.

FIG. 18 shows a diagram of the group “A” with unit 1, 2 and 3, group “B” with unit 3, 4 and 5 and group “C” with unit 3.

FIG. 19 shows a diagram of network monitoring agents.

### DESCRIPTION

While the specification concludes with claims particularly pointing out and distinctly claiming the subject matter that is regarded as the invention, the invention will now be further described by reference to the following detailed description of preferred embodiments taken in conjunction with the above-described accompanying drawings.

As used herein, the term “node” can be either a physical host on a network, i.e., a pocket personal computer, a personal computer, personal digital assistant, cell phone, etc. or part of a technical description of a data structure, i.e., the tree generated from a group key generating algorithm. Throughout the description, the term “users” generally means a human user, a node, or an agent, and such definition will be readily ascertained based on the context in which the term is used; nevertheless, “users” used in relation to applications refers to human users or agents.

I. SWAT

The Secure Wireless Agent Testbed (SWAT) is a live laboratory to study integration, networking and information assurance for next-generation wireless mobile agent systems. Specifically, the SWAT infrastructure comprises of PDA-based computing platforms on a wireless network with ad hoc routing. Although not shown, any type of computer, cellular telephone, digital or electronic device capable of transmitting information may be used instead of or in addition to PDA-based computing platforms. The physical network infrastructure is based on IEEE standard 802.11b wireless LAN technology or a technology similar thereto, using network interface cards, including, but not limited to, network interface cards manufactured by Cisco. The software infrastructure for SWAT is generally OpenSource: Linux Familiar OS 0.5.3 (Kernel 2.4.18), Blackdown Java 1.3.1, OpenSSL, IPSec, and EMAA; and non-OpenSource software infrastructure may be also be implemented in conjunction with or instead of the OpenSource code. The software is uniform across nodes.

An accomplishment of SWAT is the operational integration of a contributory group key generating algorithm in conjunction with a key agreement protocol, a messaging system for running the key agreement protocol and a mechanism for revoking the key from an agent, user, group, network or host, and demonstration of their purposeful use on live ad hoc routed networks. Group communication through a collection of agent-enabled applications that include collaboration and situation awareness has been secured on multiple layers. Secure subgroups have been created with all related key management including real-time user revocation.

The security framework uses a combination of symmetric and public-key cryptography to support encrypted communication at both the network and the agent application layers. SWAT is capable of supporting secure group communication, via shared key generation, for groups and sub-groups of computing hosts and agents. Security is monitored by agents that manage keys, assess network traffic patterns and analyze host behaviors. Using this framework, agents can revoke access rights for suspicious hosts or agents and adaptively re-route traffic at the network layer to improve the information integrity of the overall system. Lastly, agents provide the implementation framework for a number of decentralized user applications, including, but not limited to, those for user authentication, collaboration, messaging and remote sensor monitoring.

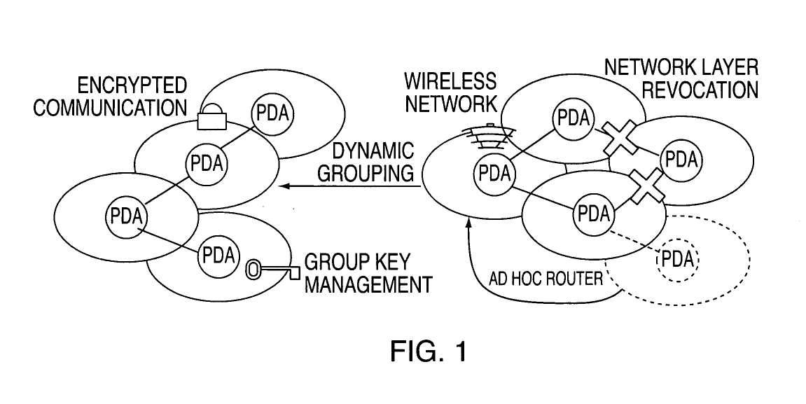

FIG. 1 shows a conceptual view of SWAT and its features. One of the features of SWAT is mobile agents can be used on ad hoc networks. Inherent with the notion of an ad hoc network is the idea that nodes can be dynamically added to and deleted from the network. This is directly contradictory with the “static network topology” assumption that most agent infrastructures make. Various research efforts (Caripe et al. 1998) have studied subsets of these problems, including those working on dynamic service discovery (e.g., the CoABS Grid (Kahn & Cicalese 2002)), but these do not create a comprehensive set of solutions.

SWAT has developed a number of techniques for agents to reason about and act on network-layer information. Agents are able to modify the network state; make decisions about their itineraries (i.e., if they are mobile agents) based on network topology; and adapt their communication modalities to avoid network congestion. For example, when agents communicate, the connectivity of the agents may not mirror the connectivity of the network—hence, a broadcast message from one agent may result in massive quantities of network traffic. One SWAT innovation addresses the difficult problem of implementing general multicast communication on ad hoc networks by allowing agents to select how to multicast based on current network topology.

Another feature of SWAT is it provides for security for mobile agents. SWAT addresses the need for a mobile agent information assurance framework that includes cryptography and the ability for different groups of agents to generate secure communication channels within the overall agent community. Further, agents must be able to reason about security groups and communications in a manner that allows them to adapt to a dynamic security environment in which hosts may become compromised, networks may get attacked and malicious agents may need to be identified and contained.

Security engineering for mobile agent systems is a vast problem. SWAT includes, but is not limited to, a set of agent security capabilities that are critical for improving the state of information assurance for agent networks. First, SWAT contains agents that use the cryptographic infrastructure to perform tasks such as, but not limited to, authentication, group key generation, revocation, non-repudiation, and threat profiling/detection. These actions can be performed at the user, host, network or agent level.

Second, SWAT hosts have agents meta-reason (i.e., reason about their own activities) using both security and network information. For example, what if a host in the network becomes compromised but simple removal of the host would result in a network discontinuity? In this case, agents analyze network topology and decide, from an information assurance standpoint, if it is better to remove the compromised host from the SWAT, reroute messages around it or just ignore it as it can do only limited harm.

A mobile agent is an autonomous piece of software with the ability to migrate from one computational device to another over a network. That is, it has the ability to transfer both its code and internal state between computing platforms. In the SWAT infrastructure, mobile agents manage keys, assess network traffic patterns, analyze host behaviors, revoke access rights for suspicious hosts or agents, adaptively re-route traffic at the network layer to improve the information integrity of the overall system, and provide the implementation framework for a number of decentralized user applications. Mobile agents allow a degree of robustness and can help eliminate single points of failure. Mobility allows the agents to seek out necessary resources and to perform service discovery activities. Monitoring of the status and health of distributed resources and of a dynamically changing network state can be effectively performed by mobile agents. SWAT is currently able to support industrial-strength, fielded, mobile agent architectures that include, but are not limited to, EMAA (Russell P. Lentini, et al., EMAA: An Extendable Mobile Agent Architecture, 7 (1998) (available at http://www.atl.external.lmco.com/overview/papers/930-9823.pdf)) from Lockheed Martin's Advanced Technology Laboratories (http://www.atl.lmco.com), Cougaar (http://cougaar.org/), the CoABS Grid (Martha L. Kahn and Cynthia Della Torre Cicalese. The CoABS grid 1 (2002)), and JADE (http://jade.cselt.it).

SWAT enables agents to reason about and react to network dynamics. It is implemented for ad hoc network environments, in which hosts have the ability to dynamically identify routes and forward packets between hosts that are not within direct wireless range of each other and which may require multi-hop ad hoc routes. Any host in the network may serve as a router. In the SWAT framework, agents are able to modify the network state, make decisions about their itineraries based on network topology, and adapt their communication modalities to avoid network congestion. Ad hoc routing is necessitated in mobile computing environments by highly dynamic conditions such as nodes entering or leaving the network for any number of reasons (e.g., being brought on/offline, moving out of range of previous neighbors, interference, etc). SWAT is not limited to any particular ad hoc routing protocol; any ad hoc routing protocol with support for multi-hop routing can be used.

SWAT addresses the need for a mobile agent information assurance framework that includes cryptography and the ability for different groups of agents to generate secure communications channels within the overall agent community. Agents must be able to reason about security groups and communications in a manner that allows them to adapt to a dynamic security environment in which hosts may become compromised, networks may get attacked, and malicious agents may need to be identified and contained. SWAT provides agents with secure multi-layer, agent-to-agent group communication on resource-constrained devices. The security framework uses a combination of symmetric and public-key cryptography to support encrypted communication at both the network and the agent application layers, including support for secure group communication. To accomplish this, established security technologies have been integrated into SWAT. SWAT is a complete integration of tools for key generation and management; secure group communication; user revocation through the use of a SEcurity Mediator (SEM); and en/decryption of traffic on the network layer. The cryptographic tools integrated in the current implementation of SWAT include: CLIQUES, the Tree Group DiffeHellman (TGDH) algorithm, Spread, Secure Spread, a SEM and IPSec.

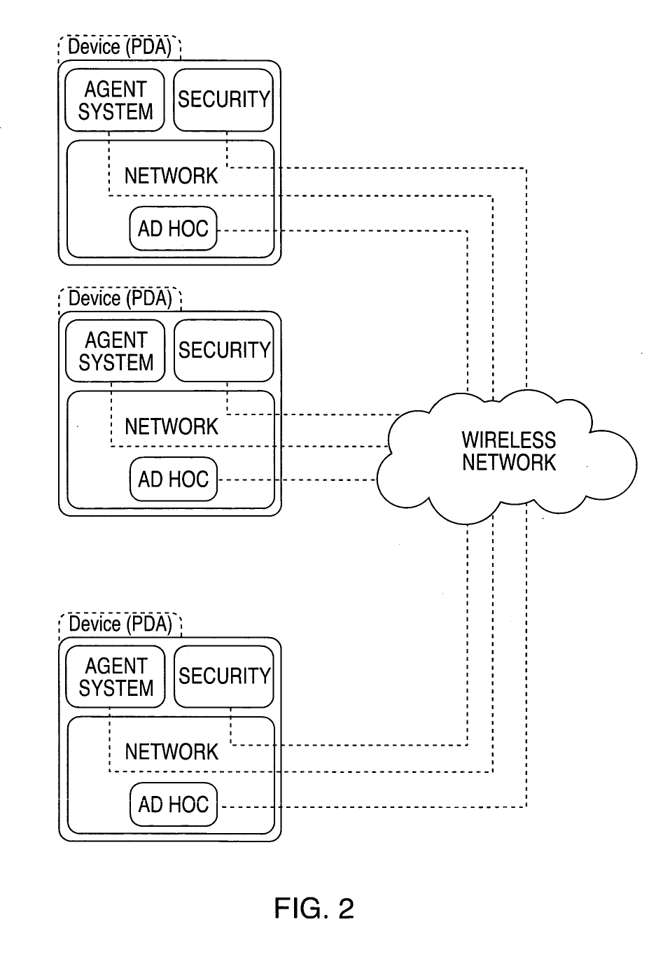

Each host in the SWAT is an integration of the agent system, the network and the security infrastructure. FIG. 2 shows the components of SWAT and how these components are connected. The agent framework contains both mobile agents and static agents (services). The security components of a host include group key management, and group membership revocation, enforced by a SEM. The agent framework is connected to the security components, enabling an agent (or the whole agent system) to join or leave a group, with the permission to join controlled by the SEM. The network components enable secure point-to-point communication for the agent framework, as well as reliable group communication for the security components. Point-to-point communication is implemented using standard TCP/IP and is secured using IPSec. Network communication is routed through a multi-hop ad hoc routing protocol on a wireless network.

Architectural Technology

Agent Frameworks

Requirements for the SWAT agent framework include: (1) provide true agent mobility; (2) be proven in production (i.e., tested, scalable, supported); and (3) be suitable for handheld computing.

Ad Hoc Networks

SWAT is implemented for an ad hoc network environment in which hosts have the ability to dynamically identify routes and forward packets between hosts that are not within direct wireless range of each other. The properties of ad hoc routing protocols have been detailed in the IETF Mobile Area Networking working group's RFC 2501 (Macker & Corson 1998).

SWAT employs a MANET, which can use a proactive or reactive routing protocol, or any hybrid thereof.

Agent systems occasionally require multi-cast or broadcast mechanisms to communicate with other agents. This poses special challenges to ad hoc networks. In a wired network, broadcast traffic is generally sent out on all interfaces except that on which it came in; this, together with loop-freedom in the network, eliminates the problem of duplicates being passed around the network forever. The nature of wireless ad hoc networks requires each node to maintain a record of those broadcast packets which it has already seen for the purpose of duplicate elimination. Different protocols deal with this problem in different ways. For example, with the AODV protocol, it has been proposed that nodes use unique identifiers to track messages (Perkins, Belding-Royer, & Das 2001). Multicast deals with communication between a group of hosts and is often used by audio messaging applications.

SWAT System Integration

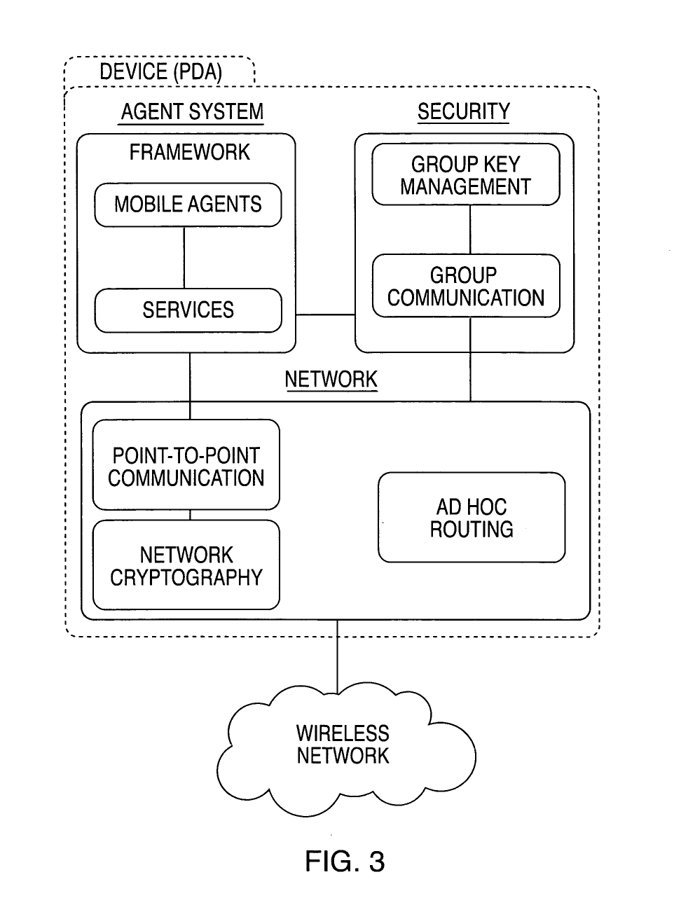

Each host in the SWAT is composed of several of the above technologies which integrate the agent system, the network, and security infrastructure. FIG. 3 shows the components of a SWAT host, and how these components are connected. The mobile agent framework, including, but not limited to, EMAA, Cougaar, JADE and the CoABS Grid, contains both mobile agents and static agents (services). The security components of a host include group key management, implemented by a messaging system, including, but not limited to Spread and/or Secure Spread (using TGDH), and group membership revocation, enforced by the integration of a mechanism for revoking the key and the messaging system, including but not limited to, the integration of SEM and Secure Spread. The agent framework is connected to the security components, enabling an agent (or the whole agent system) to join or leave a group, with the permission to join controlled by the mechanism for revoking the key. The network components enable secure point-to-point communication for the agent framework, as well as reliable group communication for the security components. Point-to-point communication is implemented using standard TCP/IP and is secured using IPSec. All network communication is routed through SWAT's 802.11b wireless or similar network using a MANET routing protocol.

When two or more hosts are present in SWAT, connections are made between hosts through SWAT's wireless network. Three types of traffic characterize the SWAT network: agent system, security, and ad hoc network management and routing. Agent system traffic is generated by the mobile agent framework, and includes agent messaging agent migration and event messaging. Security traffic, which is generated by the integration of the messaging system and the mechanism for revoking keys, includes the generation of group keys, the entry or exit of a group member, and the revocation of group membership. Ad hoc network management traffic, generated by the MANET routing, includes the maintenance and discovery of network routes in SWAT. The types of traffic in SWAT and the ability of each host to send and receive traffic of each type are illustrated in FIG. 2. SWAT employs technologies at each layer of the OSI-RM (Zimmerman 1980) to provide a comprehensive network foundation. Specific technologies that may be used by SWAT are listed in Table 1; although not listed in the table, similar technologies may be used instead of or in conjunction with those listed in the table.

TABLE 1
SWAT technologies used across the OSI-RM.

| OSI-RM | |
|---|---|
| Layer | SWAT Technologies |
| Application | EMAA, Spread, Agent Applications, Security Applications |
| Transport | TCP (EMAA), UDP (Spread) |
| Network | AODV, IPSEC, Netfilter |
| Data Link | WEP, MAC Address Filtering |
| Physical | 802.11b, 802.11a, Bluetooth, USB, RS-232 |

SWAT's security mechanisms enable both hosts and agents to belong to one or more groups. Groups provide encrypted channels for private communication. Using CLIQUES or a similar key agreement protocol, a group of hosts or agents can securely generate a shared symmetric key. Using this key, group members may encrypt messages that can only be decrypted by group members. If a group member is revoked from a specific group, the SEM will prevent that member from participating in the next CLIQUES or similar protocol generated key for that group. A specific host or agent may have membership in multiple groups simultaneously. Additionally, SWAT permits encrypted group messages to pass through non-member hosts; however, the non-member host will not be able to decrypt group messages for which it does not possess the key. Hence, it is possible for members of SWAT to perform secure group communication, even when group messages pass through non-member hosts.

In integrating these technologies, SWAT addresses many issues that future systems engineers of ad hoc, wireless agent systems will also need to consider:
1. Integration of host and agent system, providing an interface between agents and the local computing host;
2. Integration of host and security, protecting each host against active and passive network attack;
3. Integration of agent system and network, enabling agents to reason about and adapt to SWAT's dynamic network; and
4. Integration of agent system and security, so agents can form and communicate in secure groups, identify compromise agents and hosts, and make networking decisions to improve overall information assurance.
   Integration of Host and Agent System

Agent mobility depends on the capability of a host to transfer an agent's runtime state. EMAA, being implemented in Java, uses Java's thread serialization capability to implement agent mobility. SWAT uses a pre-release Java virtual machine (JVM) for ARM processors found in HP iPAQs which provides this feature. Using this JVM, each iPAQ in SWAT is capable of sending and receiving mobile agents. Alternatively, any code suitable for implementing agent mobility may be used.

SWAT's agent messaging is dependent on the continuous connectivity of the underlying hosts. This connectivity is achieved through use of a MANET wireless, ad hoc routing protocol. A multicast MANET provides a mechanism for a group of agents located on a group of hosts to perform group messaging in an efficient manner.

SWAT precludes passive attacks (i.e., eavesdropping) by encrypting all network traffic between hosts, at multiple levels, using CLIQUES or another key agreement protocol to provide forward security against “man in the middle” attacks during key generation. The encryption is performed using software provided by the OpenSSL Projects (http://openssl.org). SWAT does not rely on the weak encryption provided by WEP, which is easily broken, but creates a multi-layered, multi-group VPN over 802.11b using IPSec. Encryption and decryption at each network interface is performed using an implementation of IPSec (http://www.freeswan.org/). SWAT Agents, even when performing plain text agent messaging, can assume that their communication is only readable within the agent system.

Because each host in SWAT is networked, it is vulnerable to network attack. For this reason, each SWAT host uses a firewall to proactively filter and record any unexpected network transmissions. The firewall is implemented using a feature now integrated into the Linux kernel: netfilter (http://www.netfiolter.org). Netfilter enables each host to control the incoming, outgoing, or locally processed traffic with fine granularity. Alternatively, firewalls having a similar feature may be used instead of or in conjunction with netfilter.

The SWAT may use a customized Linux kernel and software distribution. The Linux kernel that may be used is based on the work of R. King (http://www.arm.linux.org.uk) and uses the Familiar Linux distribution (http://familiar.handhelds.org/). Other similar kernels also may be used.

Integration of Agent System and Network

There are two qualities of ad hoc, wireless networks that affect how agents can communicate. Route redundancy is the existence of more than one possible route between two hosts in a network. As SWAT's network topology changes, route redundancy between any two hosts may also change. Hence, at any time, an agent may have a choice as to how its message is sent over SWAT's network. The second quality affecting agents is the continuously changing topology in a wireless, ad hoc network. If a host becomes undesirable or unreachable, an agent may wish to avoid that host. Mobile agents use an itinerary to determine which hosts they will migrate to in the course of completing tasks.

SWAT introduces the idea of network meta-reasoning agents that can exploit route redundancy and enable the hosts, docks, services and other agents to adapt to changing network states. For example, if a host becomes compromised or is removed for security purposes, SWAT's network meta-reasoning agents can modify their itineraries or re-route agent messages to increase robustness and reduce the effect of compromised hosts. Given a disconnected or compromised host, each agent either creates a new itinerary or reports failure to its originating host.

The dynamic nature of ad hoc networks creates constant gains and/or losses of services and agents caused by network merges and disconnections. As two separate networks are combined, it may be necessary to eliminate duplicate services and agents. As a network is separated, it may be necessary to compensate for the loss of services and agents in each of the resulting networks.

II. Security

The SWAT Security Infrastructure

The SWAT Security Infrastructure (SWAT SI) includes, but is not limited to, a protocol for generating encryption keys, a reliable group messaging system, a mechanism by which user security privileges can be revoked, and packet-level security. This consists of the integration of a key agreement protocol, a messaging system, a mobile agent architecture, and a SEM for use with IPSec over a wireless, mobile, ad-hoc network (MANET). As a non-limiting example, CLIQUES, Spread, Secure Spread, EMAA, mediated RSA (a.k.a. a SEM) can be integrated. The SWAT SI enables the network to support a host of mobile applications including sending and receiving secure, authenticated group messages; non-repudiation; and instantaneous revocation of users, networks, hosts or agents.

Group Key Generation in SWAT

In secure networks (mobile and static) it is useful for several hosts to share a single symmetric encryption and decryption key. Each group has its own unique key, though members may belong simultaneously to several groups. In these circumstances it is not only necessary to provide the network with a secure protocol for generating and distributing keys, but also reacts purposefully to changes in network topology. The CLIQUES protocol suite addresses the membership problem of key agreement in a group setting with highly dynamic group member population. SWAT uses two specific protocols within CLIQUES: the Group Diffie-Hellman (GDH) and Tree Group Diffie-Hellman (TGDH) algorithms. Alternatively, other similar contributing group key generating algorithms and key agreement protocols may be used.

Reliable and Secure Group Messaging within SWAT

To enable the use of group key generation algorithms, a reliable messaging service that is generally resilient to faults across external or internal networks is needed. SWAT uses the Spread toolkit, which functions as a unified message bus for distributed applications, and provides highly tuned application-level multicast and group communication support, although any other group key generating algorithm can be used.

Secure group messaging within SWAT is achieved via an integration of CLIQUES with the Spread toolkit, called Secure Spread. Secure Spread combines the group key agreement algorithms of CLIQUES within the group messaging application programming interface (API) of Spread. Alternatively, any other key agreement protocol and messaging system that conforms to the details described herein may be used.

Group Member Revocation in SWAT

Group member revocation is an essential capability for tactical wireless networks. Revocation enables the network to respond against users, hosts or agents suspected of having been compromised or found to have exhibited malicious behavior. Typically, revocation is often accomplished as an invalidation of a certificate issued by a Certificate Authority (CA) before the original expiration date. In current practice, there have been several accepted ways to accomplish this task.

One approach is to use a X.509 Certificate Revocation List (CRL). Literature and practice have shown CRLs to be an effective method of revocation, though it is quite slow. According to Internet RFC3280, updated CRLs are published at specific time intervals defined by local policy. Until all users in the organization receive an updated CRL, users will still be able to send encrypted messages to a revoked user.

An alternative is the Online Certificate Status Protocol (OCSP) documented in RFC2560. OCSP improves upon CRLs by providing real-time revocation status messages. However, it fails to provide full invalidation of a user's private key, leading to undesirable situations if used on MANETs. Consider the following scenario: User A wishes to send User B a message using the public key infrastructure (PKI). User A encrypts the message with User B's public key after verifying that User B's certificate is valid (using OCSP). While the message is in transit, User B is deemed untrustworthy and his certificate is revoked. When the message arrives at User B, he can still decrypt the message. For systems that require immediate and full revocation, the OCSP is not appropriate.

The SWAT Security Infrastructure has developed another method for providing user revocation. Specifically, the SWAT IS uses a combination of a variant of threshold RSA and the SEM. Instead of revoking a user's certificate as in traditional methods, the SEM revokes a user's ability to perform cryptographic operations. The SEM provides immediate, full invalidation and revocation.

Mediated RSA, or MRSA, is a scheme that enables key revocation via the SEM. In SWAT, the SEM keeps half of a user's private key; therefore users need the cooperation of the SEM in order to obtain keys needed to decrypt their messages. If the SEM refuses to aid a user in decryption, a user cannot read received messages, essentially losing its security privileges.

The SEM is inserted between a CA and the network for the purpose of implementing revocation. The division of labor between the CA and the SEM is that the former determines the security policy based on operational dynamics and doctrine (i.e., who should be revoked), while the SEM executes it (i.e., denies access to keys to revoked members). SWAT presently uses the SEM for revocation only when the group re-keys, however more aggressive strategies are also possible. For example, at the expense of network bandwidth, the SEM could be required at lower levels of granularity, requiring each message decryption event to contact the SEM for its other portion of its key. The cost to bandwidth on a MANET makes this a less-than-desirable option, but it may be more suitable in settings where there is wired or wireless infrastructure. Revocation can be made instantaneous at the expense of higher computational costs, and the CA can initiate re-keying at any time to enforce instantaneous revocation.

The SWAT Public Key Infrastructure (SWAT PKI)

The SWAT PKI is the set of algorithms and protocols that support key generation, storage and revocation. This comprises the SEM, along with the messaging system for running the key agreement protocol, and a Certificate Authority (CA). The SWAT SI assumes it is at least initially attached to a system-wide CA, such as would be provided by an inter-connect to the DoD PKI (via WIN-T or as described in the FCS Network Centric Enterprise Services specifications) or one resident on one of the SWAT nodes. In this way, the CA serves the role of “commanding officer” for key generation for a SWAT platoon. Once keys for the entities in the SWAT are generated, the SEM then assumes control for key management, distribution, splits and mergers within the SWAT.

As part of the SWAT deliverables, the SEM has been distributed and is no longer a possible single point of failure. The distributed SEM (D-SEM) configuration of the SWAT takes the SEM role and distributes it across other nodes in the network.

Mobile agents may be used to make the D-SEMs mobile and to coordinate key escrow assignments with network dynamics so that nodes rarely need to contact helpers beyond their neighbors and so that vital network security and information assurance data can be re-located in the event of cyber-attack or network partitioning.

Interfacing SWAT SI with MANETs

The SWAT SI is MANET agnostic, and generally compatible with MANET protocols. It has been tested with OLSR, TSAR and AODV (note: AODV and OLSR are protocols in the CECOM MOSAIC ATD), as well as in infrastructure modes.

Use of Agents

Agents are carriers of mobile code with the ability to “migrate” from host to host, collect and provide data, monitor status, and use computing resources on visited hosts. Systems that employ mobile agents can benefit from the ability to export computation from nodes with fewer resources to nodes with greater resources. In MANETs comprised of devices with varying capabilities, for example a MANET of PDAs and laptops, the use of agents allows the workload to be distributed more efficiently. SWAT employs the EMAA from Lockheed Martin's Advanced Technology Laboratories.

Packet Level Security

The popular FreeS/WAN distribution of IPSec was selected to provide network level security by encrypting and decrypting individual packet payloads between communicating devices. Permanent symmetric keys are used, although non-permanent symmetric keys also may be used instead of or in conjunction with permanent symmetric keys.

IPSec

The Internet Protocol Security or IPSec protocol is used to secure traffic on the network layer using either symmetric keys or PKI (Public Key Infrastructure) over inherently insecure networks. IPSec encrypts and decrypts each packet leaving and arriving to and from a device. It is based on two protocols: authenticated header (AH) and encapsulated payload (ESP). Of the two, AH provides header authentication by virtue of a keyed hash function (which protects against packet replay attacks) while leaving the packet payload unaltered.

ESP provides payload confidentiality, authenticity and integrity. In tunnel mode, both the header and payload of the original packet are encrypted at the sender's gateway and decrypted and authenticated at the recipient's gateway. Tunnel mode prevents eavesdroppers from determining the payload of a packet or the specific source or destination of a packet, unless the eavesdropper is in the same network as the sender or recipient. However, since every host in a MANET is a gateway and there is no control over which host is part of which network, there is no additional benefit achieved by using the tunnel model. The inventive system uses transport mode, which encrypts the packet payload in addition to authenticating the sender and receiver.

Security Protocols and Mechanisms

The established security technologies integrated into SWAT include:
CLIQUES (Steiner, Tsudik, & Waidner 1998; Amir et al. 2000) is a protocol for key generation and management. Among other realizations, it provides implementations of Group Diffe-Hellman (GDH) and Tree Group Diffe-Hellman (TGDH) algorithms (Amir et al. 2002). The CLIQUES protocol supports key generation for dynamic group membership. The protocol is independent of the specific network configuration. It supports highly secure operations that are group extensions of the well-known Diffie-Hellman key agreement algorithm. The protocol provides contributory key agreement, which guarantees key independence, key confirmation and resistance to known key attacks. In SWAT, CLIQUES uses the group messaging features of Spread to provide keys for groups.
Spread is a client/server application for reliable group communication (Amir & Stanton 1998). The server is distributed (Spread Server segment) and each client (Secure Spread client) is logged onto the local server segment. The Spread messaging system is based on a daemon-client model where multiple long-running daemons establish a basic message network and provide membership services while user applications link with a client library. This model is useful in a wide area setting, because daemons minimize the number of membership changes that the system must carry out across wide-area links (membership changes are computationally expensive). The model also provides a basic stable infrastructure on which to build effective wide area routing and ordering. Each PDA device in SWAT has a Spread client, and it runs its own Spread server segment. Spread combined with CLIQUES forms Secure Spread.
Secure Spread is an implementation of the CLIQUES protocol using Spread as its communication platform. It is a secure group communication layer and an (API) that achieves authenticated and private communication within a group. Secure Spread uses contributory key agreement protocols, including GDH and TGDH. Secure Spread handles processor and network failures (under a fail-stop or crash-and-recover model); asynchronous membership events such as cascading arrivals (“Join” operations); member departures (“Leave” operations); group merges; and network partitions (voluntary and involuntary). It is able to handle most sequences and combinations of group membership changes. In the inventive system, all communication concerning key generation uses Secure Spread and the resulting key is used by members of a group to encrypt group messages.
SEcurity Mediator (SEM) is an algorithm for user revocation (Boneh et al. 2001). In SWAT, when a user is revoked, the SEM prevents it from participating in symmetric key generation.
IPSec is used to en/decryption of traffic on the network layer, using symmetric key(s) generated by Secure Spread (Kent & Atkinson 1997).
   SEcurity Mediator

The SEM is a server that provides user revocation capability in a secure group setting. In the SEM architecture, an offline certificate authority (CA) creates public and private key pairs for each user, using RSA. The private keys are split; one half is given to the SEM and the other half to the user. The SEM holds half of every user's private key. Thus, the cooperation of the SEM is required every time a user wishes to decrypt a message. If the SEM refuses to aid a user in decryption, that user cannot decrypt any messages and is essentially revoked. In the inventive system, the SEM assists group members in decryption of the group secret key at the last step of the key agreement protocol. By doing so, a system administrator or a certificate authority (CA) may revoke group membership privileges from selected members. The SEM is part of the network, transparent to all peer users, and is not a member of any group. It makes use of PKI to provide a means of identifying and revoking individual members. In the present implementation, the only interaction of users with the SEM occurs at the last stage of key generation, when the “sponsor” of the key-generating event in TGDH transmits group architecture information and vital encryption data to all members. When the CA adds a member to the SEM's revocation list, the SEM will refuse to assist that user with partial decryption, preventing the user from decrypting any message it receives and essentially revoking the user's ability to calculate the next group secret key.

In addition to revocation, the CA may also initiate re-keying on demand. Generally, when an arbitrator such as a SEM is used it becomes a bottleneck (it is involved in every communication). Use of SEM only during re-keying was a compromise between the desire to provide a real-time revocation mechanism and the need to keep network management overhead to a minimum; incorporation of the SEM in every decryption event is possible. Alternatively, the CA may initiate re-keying proactively.

Integration of Agent System and Security

SWAT agent security is realized through secure group communication.

Generally, when an arbitrator such as the SEM is used in computer architecture, it becomes a bottleneck in any large-scale implementation due to the fact that it is involved in every transaction. To avoid considerable time-cost in implementation of the system, the SEM is being used in conjunction with the TGDH and GDH (or similar) protocols only for the last step of the protocol generating the new symmetric key. This occurs when a new user joins, an existing user leaves, or when entire groups merge or partition. A CA may also initiate a new re-key on demand. Alternatively, the bottleneck caused by the SEM may be further mitigated through distribution of multiple SEMs throughout the network.

SEM and GDH

In order to achieve revocation, all users are authenticated through the use of the SEM. There are two major ways of achieving this: (1) instantaneous revocation or (2) passive or delayed revocation. Instantaneous revocation can be achieved by having every message sent be encrypted with the users public key, but this, very quickly becomes expensive. A more reasonable solution would be to pursue passive or delayed revocation. This form of revocation only happens at time of key generation (due to join, leave, merge, partition, key refresh) where at the last step of the GDH protocol the sponsor sends to each user Uᵢ|iε{1, 2, . . . n−1} the token as usual, but encrypts it with each users public key

$$( α \frac{{r}_{1} {r}_{2} … {r}_{n - 1}}{{r}_{i}} )$$

mod p ^{e}^{₂}. Instantaneous revocation is possible if and/or when the revocation list is updated on the SEM or the CA or the SEM alerts the group that the group should re-key, thus removing the revoked user.
SEM and TGDH

In the TGDH protocol, when a new user joins or an existing user leaves the group, another user will sponsor the join or leave operation. The sponsor is the shallowest, right-most node in the tree. The sponsor's responsibility consists of rearranging the local tree structure and broadcasting to the group the new tree structure and blinded keys. The new tree structure and blinded keys are then sent as a unicasts to each user of the group, which is encrypted with the recipients' public key. Therefore, the user will have to interact with the SEM in order to decrypt the message containing the new tree structure. The SEM checks to see if the user is revoked, and if the user is in good standing, the SEM will partially decrypt the message with the SEM's portion of the private key and send it back to the user so that he may complete the decryption and receive the new tree structure. If the user has been revoked, the SEM will not assist in decryption and the user will not be able to calculate the group key, effectively revoking his ability to read and send messages.

To generate a shared group key, CLIQUES relies on the TGDH key agreement protocol. Rather than collecting the key contribution of each member in sequence, requiring linear time, TGDH imposes a binary tree structure over the members of a group, reducing key generation to logarithmic time. Moreover, the tree structure enables CLIQUES to efficiently re-compute a key in the event that a member joins or leaves (or is revoked from) a group.

The SEM records each revocation and prevents revoked members from participating in the next key generation. If instantaneous revocation were enforced, every communication would have to be routed through the SEM. Due to the high computational and network cost of this approach, the present SWAT enforces revocation at the time of the next key generation.

Traditional security mechanisms have been applied to agent systems, including trail obscuring code obfuscation, and audit logging (Greenberg et al. 1998). Beyond traditional security mechanisms, agents provide new possibilities in computer security. SWAT advances a new approach to agent-based security that allows agents themselves to reason about security and how they affect it. In SWAT, agents can implement their own active security measures.

Design Considerations

Key Sets

In order to simplify the discussion, it is important to enumerate all the “keys” that are mentioned. In the implementation of the CLIQUES protocols, there are two keys that are discussed and another in the implementation of SEM: (1) the Group Secret Key (Symmetric Key Encryption) comprising (a) GDH—each user's random number and (b) TGDH—keys and blinded keys at each node; (2) Public/Private Key used for signatures (DSA)—used by CLIQUES to sign all transmissions over the insecure network to verify the validity of the received tokens; (3) SEM Public and Private Key (RSA)—(a) the user is given a bundle of their Public Key and half of their Private Key and (b) SEM is given (i) a SEM Public and Private Key Pair, (ii) half of each user's Private Key and (iii) a revocation list.

There are generally two choices on how to handle these sets of keys. The first is to simply do nothing, designing the system and generating three sets of keys as intended in their original implementation. The second is combining the latter two sets of keys into a set of RSA Public/Private Keys.

In order to decide how to proceed, as far as keys are concerned, it is important to have a general basis of DSA vs. RSA (signatures). To date, there have been no security compromises discovered regarding DSA signatures. Many systems use DSA including SSL, OpenSSH, OpenSSL, TLS, SSL-enabled web browsers, GnuPG, etc. As stated previously, the RSA algorithm allows for both encryption and digital signature of a message. There are a number of known attacks against this algorithm. However, it is considered no less secure than DSA. Current implementation of RSA creates two sets of keys, one for signatures and another for encryption. As far as the inventive implementation is concerned, three sets of keys are used, but for simplicity a set of DSA keys for messages signatures and RSA for the SEM system is utilized.

New Member Revocation

This is the trivial case where a member has been revoked and is trying to join a group. This may occur when a user was revoked and was forced to leave the group, but for some reason tries to rejoin the group. Effectively this is the case where the member is a non-sponsor and it is handled the same way as a non-sponsor revocation, discussed below.

Sponsor Revocation

Due to the integration proposed above, the sponsor sends the updated tree structure and blinded keys (for TGDH) or the tokens (for GDH) to all other users encrypted with their RSA public key. Therefore the sponsor does not need to go through the SEM in order to get the necessary information to calculate the next group secret key, the sponsor already has it. Because the sponsor is chosen by taking the shallowest rightmost node, if a user was a sponsor during this event, it is unlikely that he will be a sponsor during the next membership event. Since, in the next event, he will not be the sponsor, he will be effectively revoked as described herein.

Non-Sponsor Revocation

This section relates to effectively revoking a specified member. The question presented is what happens after a member has been revoked?

After Revocation

After the SEM has refused to assist a member in the decryption of the new tree structure and blinded keys, a “phantom node” is created. “Phantom nodes” are users that have contributed to the group key, but have not been able to calculate the group secret key. All other users assume that this user has successfully calculated the group secret, so during the next membership event, they will not be able to participate and this operation will fail. There are several ways of handling phantom nodes described below.

Ignore

A simple solution is to ignore that there was a phantom node created and proceed with normal life. This causes a few problems though. Because of the Virtual Synchrony (VS) requirement of Secure Spread, the flush protocol is used. Flush requires that all users flush before the next key is generated, however if a user has become a “phantom node” then that user will never flush and everyone will be frozen waiting for that user to flush.

Next Member Check

A possible solution to remedy these “phantom nodes” may be to have each member check the next member. Because of the promises of VS, each member sees the same view and order of all members in the group (they receive the member list from Spread). Regardless of the key generation protocol used in Secure Spread the member list is received from Spread and each member knows the next member on the list. Each user Mᵢ can be responsible for checking to see if the next user Mᵢ+₁,M₁ for Mₙ was able to receive the group key by sending a predetermined “hello message” encrypted with the group secret. If user Mᵢ₊₁ does not reply (after t seconds and m tries), then Mᵢ is responsible for alerting the group to perform a leave operation on them.

Sponsor Check

The solution mentioned in the previous section suffers from the weakness that if two members in sequential order (Uⱼ&U₊₁,jε{1, . . . , n}) on the list are revoked in the same operation, then Uⱼ₋₁ will perform the leave operation. However, this operation will fail because Uⱼ₊₁ has become a. “phantom node.” Since the sponsor will not be revoked and the next group key will not be obtained, it is possible to have the sponsor be responsible for sending the “hello message” to all group members. If all group members do not reply (after n seconds and m tries), then the sponsor is responsible for performing a leave operation on all of those that have been revoked. This has the added benefit that if multiple members have been revoked they can all be removed at the same time (mass leave operation).

SEM Inform Group

Another possible remedy for the “phantom nodes” is to have the SEM inform the group whenever a user attempts to decrypt a message but is on the revocation list. The group will then perform a leave operation on that member. There are a number of concerns with this method. First, the SEM will have to have knowledge of the group. It is very appealing to have the SEM as a completely impartial third party that only assists or does not assist in the decryption of a message and does not have intimate knowledge of the group. Second, any messages sent over the network raises concerns, especially when dealing with removing a member from the group. This last concern raises a final possibility.

User Leave

If it is desired to not minimize messages over the insecure network, then it may be preferable to have the member that has been revoked leave the group on his own accord. In other words, if the SEM does not help the member decrypt, then that member leaves the group.

The TGDH Protocol

An outgrowth of the GDH protocol, the TGDH protocol is a contributory key agreement protocol, where each user Uᵢ selects a random number rᵢ and is then able to generate, in cooperation with its group members, the next group secret key.

Each group member contributes to the group key, which is calculated as a function of the keys of all the nodes in the TGDH tree. The root node is the top most node. A node's parent is the node directly above. A node can have no more than one parent and a node's children are the nodes directly below; a node can have at most two children. Sibling nodes are any two nodes with the same parent. The path from any node to the root node follows that of its parents. A node's co-path is the set of nodes that are the siblings of the nodes in its path. The shallowest node(s) is any node that has no children and has the shortest path to the root. The tree's height is the number of rows.

The user nodes are the nodes with no children, denoted by Uᵢ. Each user Uᵢ selects a random number, rᵢ, and this is its secret key. All other nodes are used by the protocol to generate the group secret key (the key at the root node) through intermediate exponentiation operations. Each node of this tree consists of a secret key and blinded key. The key tree is constructed by calculating, at each node, α raised to the product of the keys of its children (α^{KeyChild}^{₁}^{KeyChild}^{₂}) where KeyChildᵢ is the secret key of a node's child). A node's blinded key (BK_{l,v} where l and v are the row and column used to specify the node) is a function of its secret key, K_{l,v}. The function f (K_{l,v}) is defined as a α^{r}^{₁}^{r}^{₂} mod p.

Each user can compute the group secret key with knowledge of his own secret key, rᵢ (a random number generated by the user), and the blinded keys along his co-path. Note that in order to calculate the keys along his path, the member must have knowledge of the tree structure. No user knows the entire key tree (users are only able to calculate the keys on their path). This is why it is necessary to have the blinded key tree. This tree is transmitted to each member at a re-keying event (“Join,” “Leave,” “Merge,” and “Partition” operations) and each individual user is able to calculate the new group secret key. The key used for encryption is a one-way hash (i.e., MD5) of the group secret key (the key of the root node).

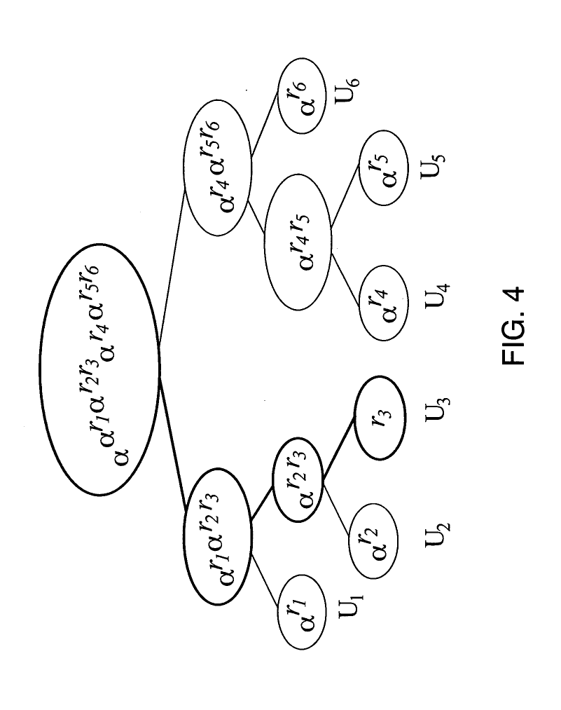

To explain how TGDH creates a key, consider in detail an example of six users (assume that the group tree structure is of the form of FIG. 4).
U₇ requests to join the group, included in this message is U₇'s blinded key α^{r}^{₇}.
The sponsor is chosen, the shallowest rightmost node, from tree structure of previous key generation (FIG. 4 the sponsor will be user U₆).
Sponsor (U₆) chooses new key r′₆.
U₆ calculates new tree structure (FIG. 4).
U₆ (the sponsor) broadcasts to all users {U₁, U₂, . . . , U₇} the new Tree structure and Blinded Keys.
Each Userᵢ calculates the next group secret key

$${GSK}_{t}^{w} = {α}^{{α}^{{′1α}^{{′2}^{′} 3}} {α}^{{α}^{r4r5} {α}^{r6r7}}}$$

by using the blinded keys on their co-path and their key rᵢ.

The computational complexity of this protocol is the following where h is the height of the tree:
Join/Merge—
   Messages (Broadcasts)=3
   Exponentiations=(3 h)/2
Leave—
   Messages=1
   Exponentiations=(3 h)/2
Partition—
   Messages=2 h
   Exponentiations=3 h
      Integration

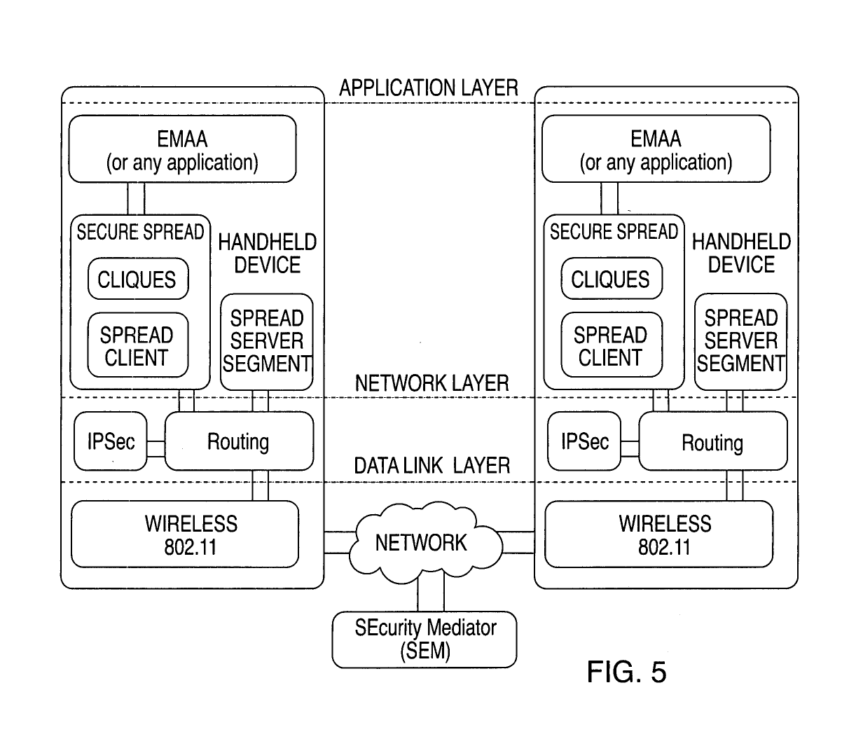

FIG. 5 depicts two PDAs with all SWAT components. On each PDA, EMAA resides at the application layer and obtains group key information from Secure Spread to encrypt application communication. Secure Spread also operates at the application layer and uses the TGDH algorithm within the CLIQUES API to engage the PDA in contributory group key agreement with other SWAT PDAs. All PDA-to-PDA communication is routed over an ad-hoc network by a routing algorithm, which uses IPSec for packet encryption and authentication. The SEM resides on a separate machine and intervenes at the last step of key generation.

Mobile Agent Computing Systems

Literature exists in which mobile agents are defined or formally expressed. Presently, the FIPA abstract architecture is used to serve as a common language and to support the standardization of agent terminology (FIPA abstract architecture specification (2002)). It is assumed that the message transport service is able to transport an agent and its state. In general, agent mobility may be represented as an additional service in the agent system.

A FIPA-compliant system has several mandatory elements, including: (1) an agent, which may or may not be mobile and is an autonomous unit of software within an agent system; (2) a service that is a service provided for agents; (3) an agent communication language that is used by agents to communicate; (4) an agent directory service that tracks and responds to queries regarding the location of all agents within an agent system; (5) a message transport service that facilitates communication between agents; and (6) a service directory service which tracks and responds to queries regarding the location of all services within an agent system.

The FIPA abstract architecture is sufficiently general as to be applicable to any agent system, including mobile agent systems. However, due to many possible implementation-specific approaches, agent mobility is not specified in the FIPA abstract architecture. The Message Transport Service is assumed to be able to transport an agent and its state. In general, agent mobility may be represented as an additional service in the agent system.

Mobile Agent Security

A common platform for an agent system is a group of networked computers; an agent may be able to choose to continue its execution on a different host in an agent system. An agent system that allows agents to move between hosts is a mobile agent system, thus freeing units of software from limiting their runtime existence to only one host or set of resources. From a security engineering perspective, mobile agent systems introduce new channels and possibly layers, resulting in additional security concerns. The majority of work in mobile agent security focuses on security mechanisms. Some work exists that begins to identify actors, assets and threats to agent systems. The invention includes agent mobility in the security engineering process.

Notation

An agent principal is denoted by A, and a service principal is denoted by S. The set of all agents is A, and the set of all services is S. The unidirectional channel from one principal, A, to another principal, S, is denoted by the ordered principals: \overline{AS}. A bi-directional channel between principals A and S is denoted by the unordered principals: {double overscore (AS)}.

If the bidirectional channel {double overscore (AS)} exists, so do the unidirectional channels \overline{AS} and \overline{AS}. The set P denotes all principals. in a system, and the set C denotes all potential channels in a system. Note that P=A∪S and C=P×P.

In a FIPA-compliant agent system, S_{M} represents an instance of the Message Transport Service, S_{SD} represents an instance of the Service Directory Service, and S_{AD} represents an instance of the Agent Directory Service. Also note that S_{M}, S_{SD}, S_{AD}εS.

An outcome is denoted by O, and in general, there are four possible outcomes: O_{D} (disclosure), O_{I} (interruption), O_{M} (modification), and O_{L} (loss).

A threat is defined by an actor, α an asset, β and an outcome, ω, such that αεP, βεP, and ωε{O_{D}, O_{I}, O_{M}, O_{L}}. The tuple <α, β, ω> defines the threat against asset β by actor α resulting in outcome ω.

For example, the tuple <A, S_{AD}, O_{I}>, refers to threat of agent A causing interruption of the Agent Directory Service.

State Description of a Mobile Agent Network

A state description for a mobile agent network can be defined in terms of sets, possibly dynamic, of hosts (H) and agents (A). The dynamic features include the agent system's underlying physical network, the location of agents among the hosts, and which hosts in the network are used for agent migration and communication. In this context, a “connection” between agents is different from a network connection between hosts. However, a connection between agents requires that a network route exists between the different hosts on which the agents reside. Given H and A, the following definitions are used:

2. Agent topology, T_{A}, is a graph of the connections between agents in the agent layer: T_{A}=(A, L_{A}) where L_{A}\overline{⊂}A×A.

3. Host topology, T_{H}, is a graph of the direct connections between hosts in the network layer: T_{H}=(H, L_{H}) where L_{H}\overline{⊂}H×H.

4. Host routing, [symbol] , is a set of sequences of hosts which describes the network routes used between hosts in the network layer: [symbol] ={Rᵢⱼ: hᵢ, hⱼcⱼ: hᵢ, hⱼεH} where Rᵢⱼ is the current physical network route from host hᵢ to host hⱼ. If no route exists from hᵢ to hⱼ, then R_{i,j}=Ø.

5. Agent location, η, is a function mapping an agent to the host on which it is physically located in a given state: ηA→H. Inversely, the function η⁻¹ maps a host to the set of agents located on that host.

The state of a mobile agent network is defined as a tuple: N=<T_{A}, T_{H}, [symbol] , η>

Security Engineering for Mobile Agent Systems

The first step of the agent system security engineering process is the determination of assets, both principals and channels. This is followed by the determination of actors. Given the assets and actors, threats are described in general, and specific examples are given. Security mechanisms are then developed for these threats and security is evaluated. The agent security engineering process is then iterated.

Process

There are several existing processes for security engineering described in literature. The invention employs a general process as informally described by Ross Anderson in “Security Engineering: a Guide to Building Dependable Distributed Systems (2001): (1) determine assets; (2) profile threats; (3) create policy; (4) develop mechanisms; and (5) evaluate security.

Using this informal process as a starting point, a formal approach to agent security engineering was developed. The inventive agent security engineering process takes each of these steps to the next level, specifying each step in a finer level of detail formalizing the process throughout all layers of an agent system.

Determine Assets

Enumeration of assets determines what needs to be protected. One of the most common mistakes in security engineering is to ignore an asset or threat. This happens because an engineer is not aware that the asset or threat exists, or the engineer considers an asset or threat as being irrelevant to security.

In agent systems, the majority of work focuses on threats against agents realized by a “host.” The difficulty of the hostile host problem is evidence that agents researchers do not go into sufficient depth to address security. In other words, what is a “host” in an agent system? There are many implementation dependent answers to this question, but in all cases, a host is composed of more than one principal and more than one layer.

In a FIPA-compliant agent system, a host comprises several mandatory services: S_{M}, S_{SD}, and S_{AD}. It is also mandatory that at least one instance of an agent exists, denoted by A. These entities are the principals, and the cross product of these represents the possible bi-directional channels. Together, the principals and channels form the minimum set of assets for a FIPA-compliant agent system. This set grows as an agent (a principal) and its means of communications (channels) are added to the system.

Formal language with which to model and describe the assets of an agent system has been developed. The common types of assets that are inherent to agent systems in general has been determined.

Profile Threats

Threats are realized by actors in a system. Each principal PεP is an actor. An actor realizes a threat against another principal, channel or protocol through an instance of a channel to another principal. Each realized threat results in an outcome involving the assets of the targeted principal, channel or protocol. Through the enumeration of all unidirectional channels within a layer, it is possible to create a complete characterization of the possible threats against assets within that layer. For each unidirectional channel, an actor can realize a threat against the channel, the targeted principal or the protocol corresponding to that channel.

The minimum set of threats within a FIPA-compliant agent system is all sets <α, β, ω> where α, βε{A, S_{M}, S_{SD}, S_{AD}}. In profiling possible threats, those with the most valuable assets and most untrusted actors should be addressed. Policies and mechanisms selected may be best evaluated through empirical methods using experiments to realize threats against the system before it goes into production.

Create Policy

Given a complete picture of the assets and threats, it is possible to determine which threats pose the most risk to the assets. It is seldom the case that all threats in a system can be addressed, and all threats generally cannot be eliminated. Given a set of significant threats to address, a policy is needed to determine how to counter them.

A policy describes how the selected threats in a system are to be addressed. This step is frequently avoided, or construed as unnecessary. The purpose of a policy is to enable one to choose mechanisms that directly address the threats. Without a policy, one cannot evaluate whether the mechanisms have been successful at minimizing the risk to the assets as expected.

A good policy is highly dependent on the implementation of an agent system and its application. However, there are several informally described policies that re-occur in existing agent and security research: (1) all principals trusted: all hosts, agents, and services are trusted; (2) trusted hosts, entrusted agents: all hosts are trusted by all agents, but neither hosts nor agents trust other agents; (3) trusted agents, entrusted hosts: all agents are trusted by all agents, but some or all hosts cannot be trusted, nor do they trust the agents in return; (4) Bell-Lapadula: an agent or host can only access other hosts or agents at or below its own level of access; (5) Lattice: an agent or host can only access other hosts or agents at or below its own level of access in more than one access category (e.g., level of access can be “top-secret” for the Message Transport Service, but only “restricted” for the Service Directory Service); and (6) RBAC: an agent or host can access other agents or hosts based on its current role within the agent system.

Develop Mechanisms

Given a security policy, mechanisms must be selected or developed to enforce it. Note that the mechanisms are selected only after it is known exactly which assets, which threats, and what policy are being employed within a layer. There is a plethora of mechanisms available, especially for using cryptography and key management in a specific layer of a system.

Common types of mechanisms include authentication, integrity, confidentiality, non-repudiation and revocation. Authentication verifies a principal's identity. Integrity ensures that data content remains unmodified and in its original form. Confidentiality precludes disclosure of information to unintended recipients. Non-repudiation precludes principals from rescinding previous data. Revocation enables a principal to rescind privileges given to other principals.

The inclusion of a mechanism may introduce a new principal, and subsequently new channels and protocols, into the system. In such cases, it is necessary to repeat the process, beginning with the determination of new assets.

A formal methodology or rule system for the selection of security mechanisms given a description of assets and threats and the chosen security policy is described herein.

Evaluate Security

The final step in the process is to evaluate how well the selected mechanisms enforce the security policy. The ultimate consideration is whether or not the risk to the system's assets has been minimized as expected. There are several formal methods for evaluating the security of any general computing system. The Common Criteria is the current United States standard for the evaluation of security in information technology. Formal methods of evaluation are useful for obtaining certifications and for comparing security between systems.

Active probing and “controlled attacks” against a system are a good practice in addition to formal analysis, as the implementation of mechanisms or other implementation details (e.g. bugs) may field security holes that are not addressed as intended. Existing security tools (e.g., SATAN, COPS, Internet Scanner, etc.) can be used to actively evaluate security in commonly studied layers, such as the networking and applications in UNIX-based systems. Due in part to the implementation-dependent details of agent systems, there is currently no known tool for probing agent system security.

The first steps in the development of a tool for the probing of agent system security is described herein. These steps include applying the Common Criteria to the evaluation and addressing any short-comings that may crop up in its application to mobile agent systems.

III. Agents

Information Assurance for Mobile Agent Systems

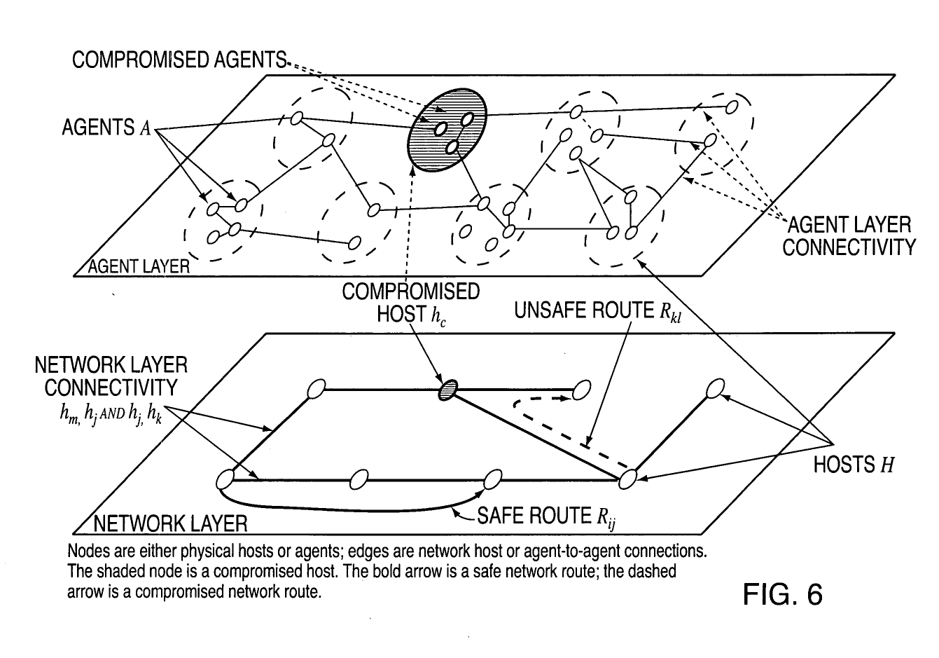

A practical means of measuring information assurance for mobile agent systems operating on wireless, ad hoc networks based on meta-reasoning to improve the security of communications is now described. FIG. 6 shows an agent system and its two distinct layers of communication: host-to-host and agent-to-agent. Given the plethora of new techniques for identifying network intruders, the compromised host problem is considered: determining the appropriate response to an identified intruder. In the context of a mobile, multi-agent system operating on an ad hoc network, it is not merely a simple matter of removing the compromised hosts and its agents. While keeping the compromised host can result in information disclosure, removal of the host can degrade or even sever the network. A measure of information assurance for the system can be defined in terms of the integrity of the messages delivered to the agents in a given network state. Agents have three responses to a compromised host: ignore the compromised host; reroute around the compromised host using network route redundancies; or remove the compromised host, by having the agents instruct their hosts to eliminate it from the network.

Preliminary Analysis: Host Topology Known

The information assurance level in an agent network can be modeled by analyzing how agents communicate. Observe that agents must send messages to other agents in order to collaborate in any decision procedure. In a decision procedure, typically certain agents are authorities that collate voting messages from all other agents involved in the decision. In the context of T_{H} any host housing an agent involved in at least one decision procedure authority is a sink in the network topology graph into which messages flow. For a simple decision, there may be only one sink; in the most complex case, all hosts are sinks. This preliminary formulation assumes the case in which all hosts are housing decision authority agents. This preliminary formulation also assumes that the hosts are housing host topology T_{H} is known.

Evaluation of an Agent System Network

Agents must send messages to other agents in order to collaborate in any decision procedure. In a decision procedure, typically certain agents are authorities that collate voting messages from all other agents involved in the decision. In the context of T_{H}, any host housing an agent involved in at least one decision procedure authority is a sink in the network topology graph into which messages flow. For a simple decision, there may be only one sink; in the most complex case, all hosts are sinks. It is assumed that all hosts are housing decision authority agents.

For any decision procedure, messages sent to the decision authority can be classified into successful messages and failed messages. A successful message is delivered without using the compromised host. A failed message either: (1) originates or ends at the compromised host; (2) is routed through the compromised host; or (3) cannot be routed because no network route exists.

For a given N, a change in T_{H} can cause a change in routing. If a route changes, the time taken to transmit a message over that route may also change. A change in message delivery time can negatively impact a decision, procedure. Moreover, a compromised host contains agents that may violate their expected behavior in a decision procedure. Both factors must be considered when evaluating a state N. Two values that can be used to evaluate N with respect to each factor are defined as: (1) a message integrity rating, which relates successful messages received to failed messages; and (2) a time rating, which is an estimate of optimality for the current network routes.

Measuring Message Assurance

If each agent is in communication with all of the other agents, nᵢ=(|A||η⁻¹(hᵢ)|)|η⁻¹(hᵢ)|) is the total number of messages that the agents on host hᵢ expect to receive from agents on other hosts per unit of time given state N. Based on the current routes [symbol] , one can calculate the number of successful messages received on host hᵢ, succ(hᵢ). The message integrity rating for host hᵢ is computed as:

$${m}_{i} = \frac{succ ( {h}_{i} )}{{n}_{i}} .$$

Note, as mᵢ increases, the integrity of messages sent to host hᵢ also increases. When all messages sent to hᵢ are successful, mᵢ=1.0. When all messages sent to hᵢ fail, mᵢ=0.0. The mean message integrity rating over the entire mobile agent network in state N is:

$$\overline{m} = \frac{{\sum }_{i = 1}^{\vert H \vert} {m}_{i}}{\vert H \vert} .$$

Measuring Network Routing Efficiency

The tradeoff is between message integrity and the timeliness of message delivery. Network routing algorithms find sets of routes that minimize some value for all routes in a network. In general, routing algorithms use a weight function on each route and find the shortest, single source, paths to all vertices in T_{H}. In this context, the function p represents the network routing algorithm which returns a set of shortest path routes for the set of hosts, given their current physical network topology: [symbol] =p(H, L_{H}, w), where w is the weight function. There are several schemes that can be used to weight routes in wireless, ad hoc networks, all of which can be approximated or bounded using a w that returns a value to the time required to transmit a message through the network. The units of time proportional returned by w are used for relative comparison of network routes, which are normalized w to simplify computations: w: [symbol] →[1,|H|], where w(R_{i,j})=|H| signifies that the route from host to hᵢ to hⱼ is non-existent and weight of the longest possible route is |H|−1. Now a time rating, tᵢ, for the network routes used by host hᵢ can be defined as:

$${t}_{i} = \frac{{\sum }_{j = 1 , j \neq i}^{\vert H \vert} w ( {R}_{j , i} )}{\vert H \vert ( \vert H \vert - 1 )} .$$

Note, as tᵢ increases, the routing efficiency to host hᵢ decreases. When the routing efficiency is minimized (i.e., no connections exist) efficiency to host hᵢ, tᵢ=1.0. As the routing efficiency increases (i.e., shorter routes are used) for host hᵢ, tᵢ approaches 0.0. Hence, the mean time rating for the entire mobile agent network in state N is

$$\overline{t} = \frac{{\sum }_{i = 1}^{\vert H \vert} {t}_{i}}{\vert H \vert} .$$

Assurance for Entire Mobile Agent Network

A linear combination of message integrity rating and time rating defines a utility function assessing a mobile agent network in state N in terms of both assurance and routing efficiency:

$$V ( N ) = \frac{α \overline{m} - ( 1 - α ) \overline{t} + 1}{2} \qquad ( 1 )$$

α is a coefficient between 0 and 1 that determines the balance between assurance and network performance. If α=1.0, only message integrity is considered; if α=0.0, only time efficiency is considered. Note that V:N→[0.0,1.0], where V(N)=1.0 is the best possible result.

Using Equation (1), agents can decide how to operate on their network. The ignore operator does nothing. The reroute operator generates a new set of network routes, using only safe routes wherever possible. If [symbol] ′ is the set of safest possible routes, the resulting mobile agent network N′=<T_{A}, T_{H}, [symbol] ′, η> is generated using the reroute operator on N. Given the routing algorithm p and route weight function w, the following algorithm can be used to compute N′:

```
reroute (N, h_{c}) [symbol]
    ′ [symbol] p (H - {h_{c}}, L_{H}, w) [symbol]
    ′ = [symbol] ′ ∪ {R_{i,j} :R_{i,j} ∈ [symbol] [symbol] R′_{i,j} ∈ [symbol] ′ [symbol] R′_{i,j,} = Ø}
    return (<T_{A}, T_{H}, [symbol] ′, η>)
```

The remove operator results in the complete removal of the compromised host from participation in the agent system's underlying network. The new mobile agent network, N″=<T_{A}, T_{H}, [symbol] ″, η> is the result of applying the removal operator on N and is generated by the following algorithm:

```
remove (N, h_{c})
    A′ [symbol] {a:a ∈ A [symbol] η(a) ≠ h_{c}}
    L′_{A} [symbol] {(a,b) : (a,b) ∈ L_{A} [symbol] a,b ∈ A′}
    T′_{A} [symbol] (A′, L′_{A})
    H′ [symbol] H— {h_{c}}
    L′_{H} [symbol] {(hᵢ, hⱼ) : (hᵢ, hⱼ) ∈ L_{H} [symbol] hᵢ, hⱼ ∈H′}
    T′_{H} [symbol] (H′, L′_{H}) [symbol]
    ″ [symbol] p(H′, L′_{H}, w)
    return(<T_{A}, T_{H}, [symbol]  ″, η>)
```

In order to select the operator resulting in the highest valued agent system, consider the values V(N), V(N′) and V(N″). The highest of these values represents the best action for the agent system.

Network Topology and Uncertainty

The formulation presented above has assumed knowledge of the network topology. In the highly dynamic environment of an ad hoc wireless network, hosts can go offline or come online at any time. The topology of the network is ever-changing. Although it has been assumed above that the global topology can be known at any time and that there is no uncertainty in the network's topology, this is not realistically the case. Agents and hosts do not have a global view of the network. They have a topologically limited perspective. They are able to share their observations of a localized view of the network with other agents and hosts, but communicating this information takes time and the network may change before messages of this nature are delivered to their destination. The dynamics of the environment necessitates two items: (1) a model that acknowledges uncertainty; and (2) a model that can be learned from local and shared observations. One such model that was used as a starting point is as follows:

Each host hεH has some model of the network topology, T_{H}. Call this model B_{TH}^{k}. Define it generally as a function:
B_{TH}^{k}:H×H→{R×R . . . ×R→[0,1]}
That is, a host's model of the network topology is a function mapping each pair of hosts to a function that indicates the “degree of neighborness” for the pair of hosts. This degree of neighborness function is a mapping from various measurable indicators to the “neighborness” of the pair of hosts.

More specifically, we define B_{TH}^{k} as:
B_{TH}^{k}(h₁,h₂): Ageₕ_{₁}_{,h}_{₂}, Qualₕ_{₁}_{,h}_{₂}, Distₕ_{₁}ₕ_{₂}, Relₕ_{₁}_{,h}_{₂}→Neighborness,
where Qual is Quality, Dist is Distance, Rel is Reliability, and where these along with Age are defined as:

Age: The time when data was measured; how old is the information; when observation was made.

Quality: The signal strength, signal to noise ratio, etc.

Distance: The number of hops (time) between a pair of hosts.

Reliability: Some measure of reliability; can be a measure of security/information assurance; or perhaps something like error rate.

Reliability: Some measure of reliability; can be a measure of security/information assurance; or perhaps something like error rate.

Neighborness: Is a pair of hosts neighbors? Real-valued in interval [0,1]. 1 means the hosts are neighbors. 0 means the hosts are not neighbors. Intermediate values represent the degree to which a pair of hosts are neighbors. E.g., the probability they are neighbors may be one interpretation.

Machine learning techniques can be implemented for the learning of the B_{TH}^{k}(h₁, h₂).

IV. MANETS

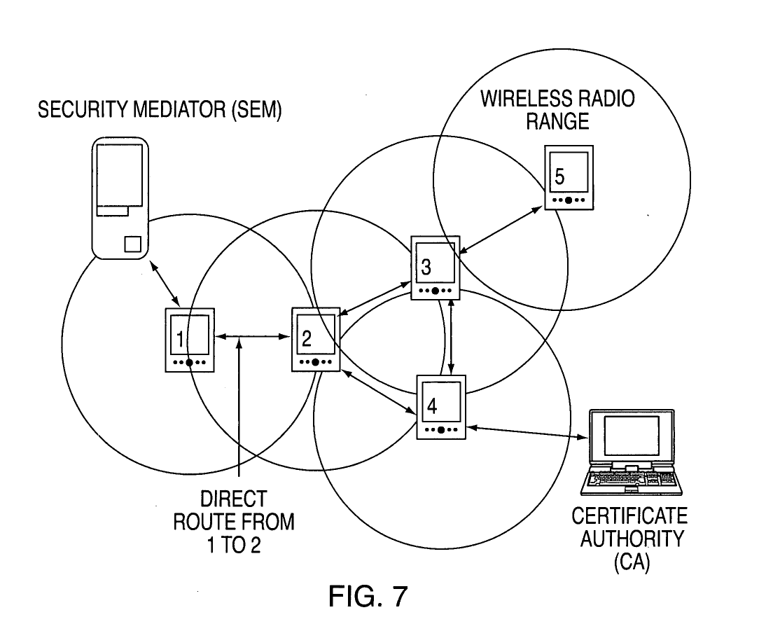

The MANET design utilized includes handheld PDAs and tablet PCs, a certificate authority (CA), and a SEM. A general diagram is shown in FIG. 7. Some units (e.g., 1 and 2, 2 and 3) have direct routes to one another. Other units (e.g., 1 and 3, CA and 5) must route through intermediaries. Alternatively, the MANET design can be any design that is capable of performing or supporting the functions described herein.

Integration of a MANET with Mobile Agents

The testbed for a MANET currently includes two agent infrastructures, EMAA and Cougaar. The EMAA framework includes autonomous and asynchronous agents as well as management mechanisms for agent mobility, agent events and inter-agent communication. While highly autonomous, EMAA agents can still receive and respond to commands from a controlling authority, thus balancing between totally autonomous behavior and cooperation to command centers that may be controlled by human users. The Cognitive Agent Architecture (Cougaar) from BBN Technologies (http://cougaar.org) offers a hierarchical grouping for agents into Cougaar Communities and Societies, which are grouping of agents and perhaps sub-communities of agents with some common functional purpose. Agents communicate using Cougaar's built-in asynchronous message-passing protocol and can be mobile across hosts in the system.

The MANET enables both mobile and non-mobile agents to perform several tasks that they otherwise could not:
Itinerary Modification. As mobile agents move, they adapt to the underlying topology and change their host itinerary. For example, agents may avoid moving near compromised hosts or express a preference for high-availability, high-bandwidth links.
Network Meta-reasoning. Agents can perform monitoring and management tasks on the network and communicate information to the MANET. An agent might be part of an intrusion detection service and inform the MANET when host policies need to be updated.
Directed Agent Messaging. Agents can reason about network routes and the effect of compromised hosts. Agents can use the MANET to re-route messages during the voting phase in which a compromised host is identified so they are not seen by that host.
System Profiling and Network Management. In the MANET testbed, mobile agents are used to periodically sample network and system dynamics. This information is used for network management, intrusion detection and damage mitigation.

### V. EXAMPLES

Validation and Experimentation

The SWAT enables the accomplishment of advanced research in the area of mobile agent system security. It provides the necessary infrastructure for research in the areas of: 1) security engineering for agent systems; 2) interaction of mobile agent systems, ad hoc networks and security; and 3) secure agent-based applications.

Given an agent system, SWAT provides the tools to conduct a security engineering process and to select the security tools necessary to implement the security policy that results as an outcome of that process. Given an agent system, the assets and profile threats to those assets can be determined. The SWAT provides the tools to customize the security policy to address those threats; and mechanisms to enforce the security for the required mechanisms.

SWAT provides the framework necessary to study the interactions of agent systems, security and ad hoc networks. For example, one can study the cost and overhead of a security policy for different agent systems; or the effects of different ad hoc routing protocols on the information assurance of an agent system. It provides a framework that can be used to empirically compare alternative security mechanisms, or alternative routing protocols, or alternative agent systems, etc.

SWAT allows for the development and study of truly secure agent-based applications. For example, some work has been completed on the development of a secure multicast, multi-group agent-based whiteboard within the SWAT. Agents deliver updates on behalf of a host's user to the whiteboard of other hosts. The ability of a host to receive these updates relies on the group membership of the host. Other potential applications include network topology and resource monitoring; and information assurance policy or the infrastructure needed to develop meta-reasoning.

Experimental Results

In order to evaluate the performance of this system, the time it takes for a key to be generated was examined.

Example SWAT Applications

An Agent-based Whiteboard

Collaboration among SWAT users is conducted via a secure multicast, multi-group whiteboard. This whiteboard utilizes a peer-to-peer architecture that employs EMAA agents to deliver messages to members of each group. Multiple users are allowed to work collaboratively without losing any of the features provided by a traditional centralized whiteboard. Whiteboard communications can be described as a complete graph in which each node represents a server on a host which uses agent messages to communicate with all the other participants. Because the whiteboard is decentralized there is no central server node, or even a server present in the whiteboard architecture. Each of the clients reside on a different host and are responsible for performing services that would otherwise be performed by a server. All of the changes produced by each of the nodes are relayed to all the other nodes through communication channels that are available in each host. The whiteboard's agents will only deliver annotations to members of the group to which the agent itself belongs.

A second application is a secure multi-group whiteboard that allows members to draw annotations to peers in their secure groups. The whiteboard uses a peer-to-peer architecture that employs EMAA agents to deliver messages to members of the various groups.

Using the whiteboard application, several users can collaborate on annotations without losing any of the features provided by a traditional centralized whiteboard. All changes produced by a node are relayed to all other authorized nodes through agent messages (as opposed to being stored on a central server). A user can send annotations to a specific group or to all groups of which it is a member. As a non-limiting example, suppose there are two users with one user in the group SWAT_A and the other user in the group SWAT_B, and both users are in the group SWAT_C. Both of the users will be able to see annotations that were made in the group SWAT_C; however, annotations made in the group SWAT_A will be exclusive to users of SWAT_A and annotations made in the group SWAT_B will be exclusive to users of SWAT_B; this results in annotations only being seen by authorized users.

Cost of Security

The cost of security was measured in four experiments. The first experiment duplicated performance testing of the TGDH protocol, published by Amir et al. in “On the Performance of Group Key Agreement Protocols,” Tech. Rep. CNDS 2001-5, Johns Hopkins University Center of Networking and Distributed Systems, pp. 339-408 (2001), on the desktop testbed in order to create a baseline for comparison. The time cost of using TGDH on the wireless PDA testbed and the time cost of EMAA on the same testbed was measured. Finally, the cost of using SEMI with the TGDH protocol on the desktop testbed was measured.

Overhead Experiment

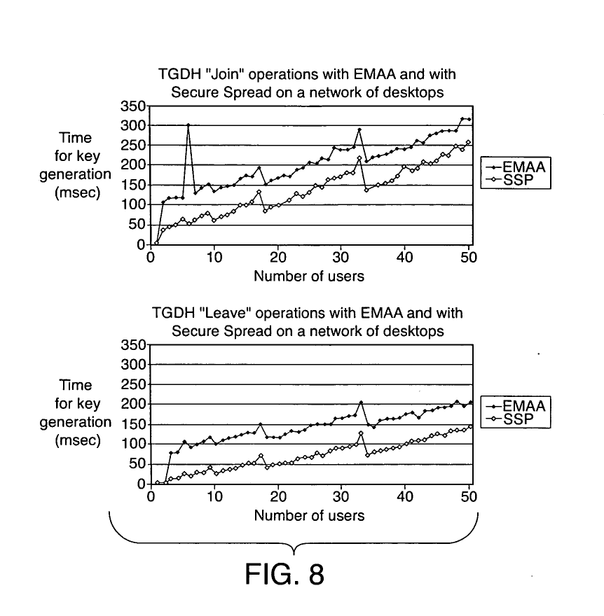

Performance testing of the TGDH and GDH protocol on the testbed was duplicated in order to create baseline performance data. The time cost of using TGDH and GDH with and without EMAA on the desktop testbed and on the wireless PDA testbed was measured. In addition, the time cost of using SEM with the desktop testbed also was measured. The desktop testbed consisted of a wired local area network populated by three 2.4 GHz Pentium IV single—processor computers running RedHat Linux 8.0 with a 1024-bit modulus. Each machine ran a Spread daemon process and members were distributed evenly on all the machines to emulate a mufti-process load. Successive group “Join” and “Leave” operations by single users were performed using GDH and TGDH, both with and without EMAA. A single user would join or leave a group, thereby prompting the generation of a new group key. The experiments involved a single group. A fourth Pentium IV system was used for the SEM. The same tests were performed with the wireless testbed. The wireless testbed consisted of a network of three 206 MHz ARM processor Compaq iPaq PDAs with 64 MB of RAM and no floating point hardware. Finally, the time cost of using TGDH and GDH with and without a SEM and without EMAA on the desktop testbed was measured. The ordinate in FIGS. 8-12 is the average time to re-key and the abscissa is the number of users in a group.

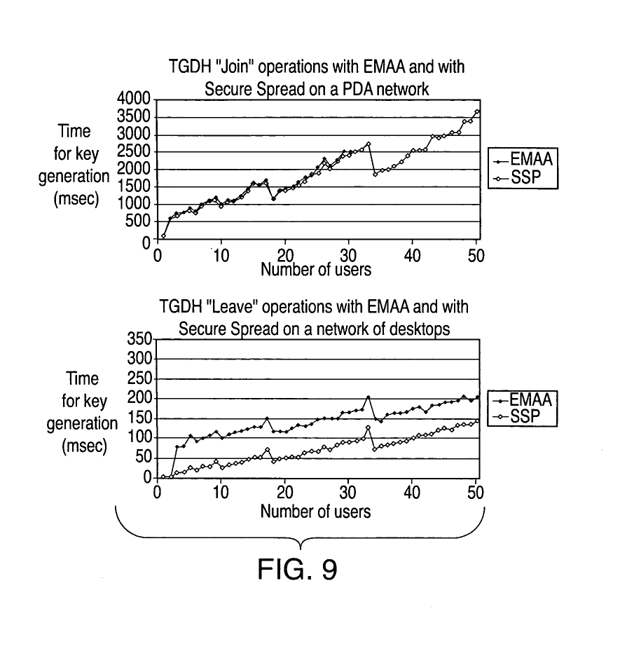

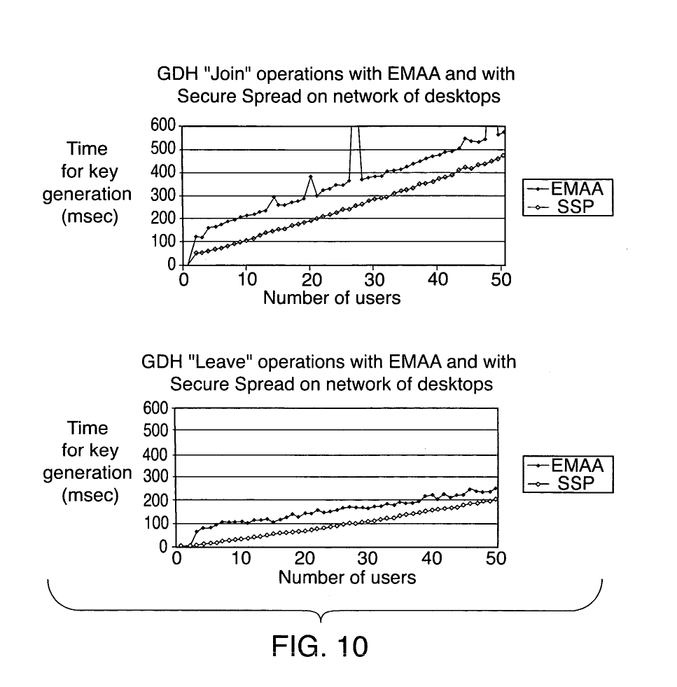

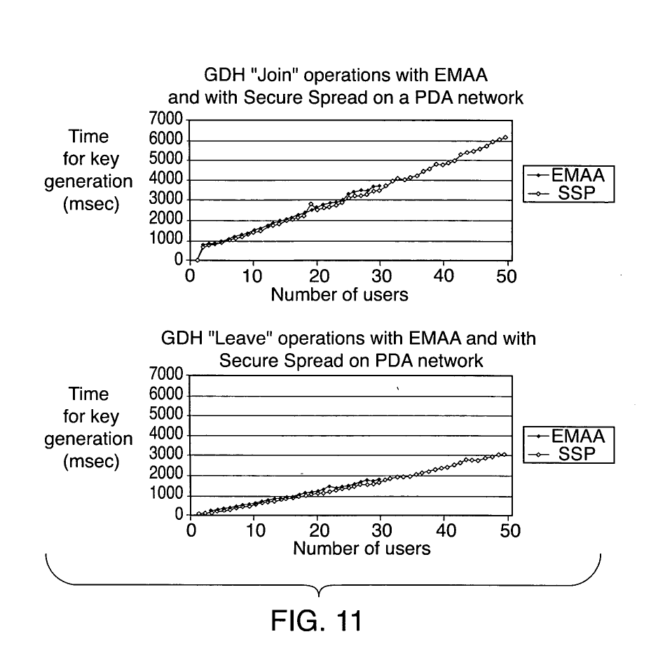

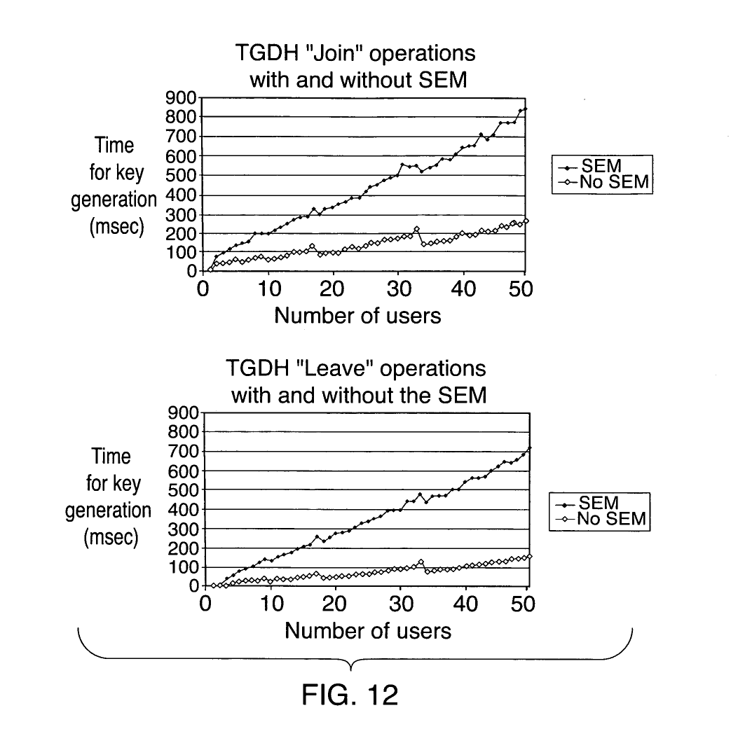

The performance data (FIGS. 8, 9) are consistent with that of Amir et al. TGDH is more efficient than GDH. In both the desktop and PDA plots, there is approximately a linear relationship between group size and re-key time. “Leave” operations generally take less time than “Join” operations (fewer modular exponentiations are required during “Leave” operations). On the PDA network (FIGS. 9, 11), both “Join” and “Leave” operations take an order of magnitude more time than on the desktop network. On both the desktop and PDA testbeds, the cost of using TGDH is less than the cost of using GDH. Also, at around 16 and 32 member group size, a large cost benefit from the use of a tree, which becomes balanced when log₂n (with n being the number of members) is an integer (FIGS. 8, 9), is seen. The two large “spikes” in re-key time that occur in FIGS. 8 and 10 are the result of Java performing memory management operations at certain (random) times. During such “clean ups” memory is reallocated or freed up. The same operations occur on the PDAs but are not as extreme (FIG. 11). FIG. 12 shows the addition of the SEM adds to the overall key generation time, but the cost still grows linearly.

Decision Making for Mobile Agents in Ad Hoc Wireless Networks: The SWAT

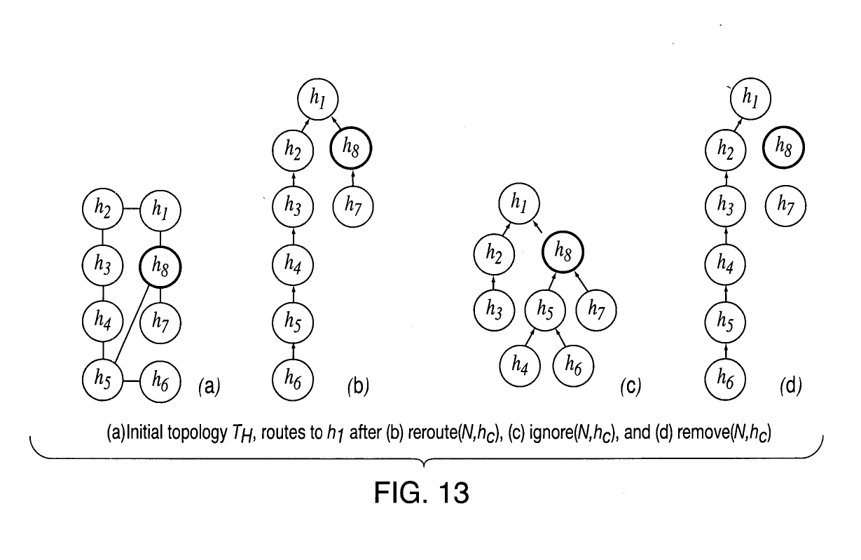

The SWAT concept is shown in FIG. 1; the testbed includes a number of mobile agent applications for authentication, key escrow, collaboration, revocation, sensor relay and network monitoring. Each agent and host in the SWAT can use V(N) to assess the underlying network for a given scenario. Two SWAT application scenarios that use this framework are presented, and both use the same initial host topology shown in FIG. 13.

Host Heartbeat Monitor

SWAT includes a “heartbeat” agent that monitors the status of all of the agents. The heartbeat monitor is a sink that expects to receive a message from each agent during each time interval. If a message is not received during the interval, it is assumed that agent has died or suffered some failure. Even though a compromised host is eavesdropping or, potentially, tampering with heartbeats, the first priority is to ensure timely reception of heartbeats.

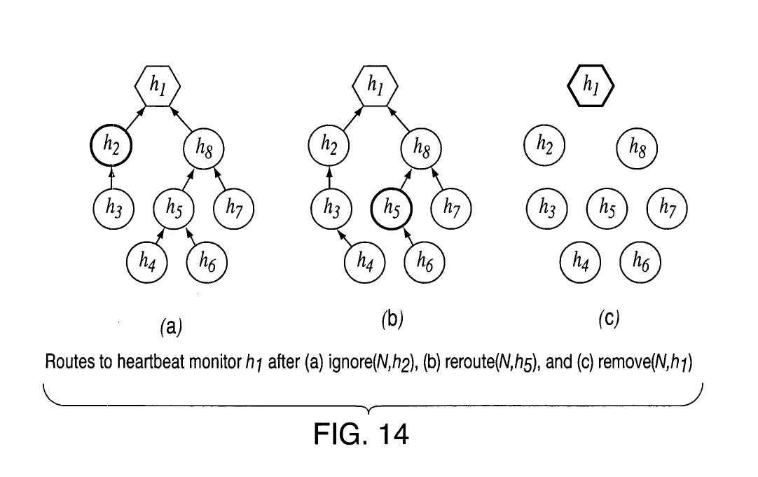

FIG. 14 shows the route trees resulting from the application of the best operator for three representative cases of h_{c}: h₂, h₅, h₁. Table 2 shows V(N) for each possible combination of h_{c} and operator when the heartbeat monitor is at h₁. Note that the highest V(N) changes depending on the location of h_{c}. If h_{c} host routes very little network traffic (e.g., h_{c}=h₂, FIG. 14(a)), or no traffic (h_{c}=h₃ or h₇), then choose ignore because there is little loss to message integrity and some gain to routing efficiency by keeping them. In the case of h₆ and h₄, they route no traffic and are too far away from the sink to contribute to routing efficiency, so it is best to remove them when compromised. If h₅ is compromised (FIG. 14(b)) rerouting is the best remedy—it is too valuable to the routing efficiency to be removed, even thought there is going to be an increase in failed messages. Host h₈ routes more traffic than h₅, but rerouting away from h₈ causes too much of a decrease in routing efficiency, so ignoring it is best when it is compromised. Finally, when the sink h₁ is compromised (FIG. 14(c)), it is best to remove it, as the disclosure is too significant (i.e., h_{c} compromises all heartbeats).

TABLE 2
V(N) using α = 0.1 for the result of each operation.
Each row uses a different h_{c},and the sink is always h₁.

| h_{c} | ignore | reroute | remove |
|---|---|---|---|
| h₁ | 0.388 | 0.388 | 0.500 |
| h₂ | 0.423 | 0.414 | 0.389 |
| h₃ | 0.430 | 0.430 | 0.421 |
| h₄ | 0.430 | 0.430 | 0.432 |
| h₅ | 0.416 | 0.423 | 0.370 |
| h₆ | 0.430 | 0.430 | 0.432 |
| h₇ | 0.430 | 0.430 | 0.421 |
| h₈ | 0.402 | 0.391 | 0.306 |

Distribution of Sensor Data

At any given time, physical hosts may be relaying sensor data to agents on other hosts. In SWAT, sensors can include things like weather data, video feeds and other sources of data. Each host connected to a sensor transmits data to other hosts. This data, like that of the heartbeat monitor, should not be disclosed except at the expense of inefficient routing. Note that this is not a simple matter of just removing the compromised host from the network, as the best balance between message integrity and routing efficiency may result from rerouting or no action.

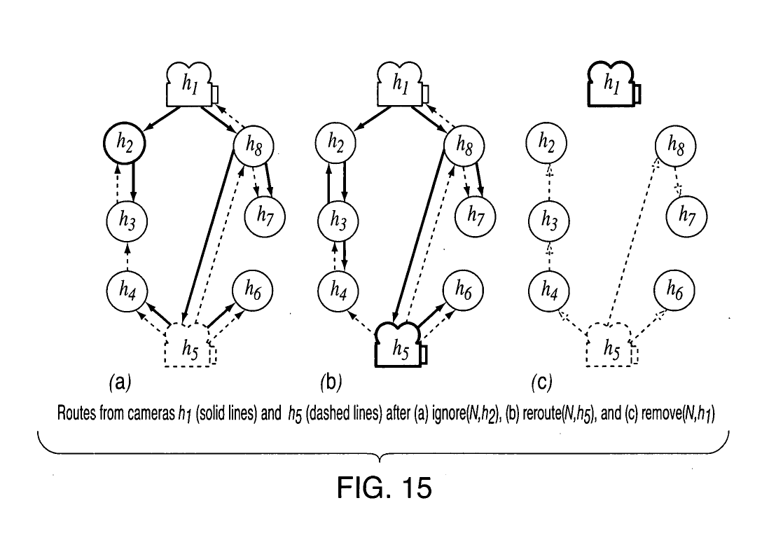

FIG. 15 shows the route trees resulting from the application of the operator yielding the highest V(N) for three arbitrary cases. Table 3 shows V(N) for the result of each operator for each possible h_{c}, given the two sensors (i.e., the video cameras) located at h₁ and h₅. Note that when h₁ is compromised, a large amount of disclosure occurs, which is best remedied by removal. Host h₂ routes the packets of only one other host for one sink, thus ignoring it yields the greatest value when it is compromised. When h₅ is compromised, one can observe that its connectivity is too valuable to remove, but the messages disclosed to it are too great to ignore. Hence, rerouting is the best solution when h₅ is compromised.

TABLE 3
V(N) using α = 0.1 for the result of each operation.
Each row uses a different h_{c},and the sinks are always h₁ and h₅.

| h_{c} | ignore | reroute | remove |
|---|---|---|---|
| h₁ | 0.362 | 0.358 | 0.400 |
| h₂ | 0.384 | 0.379 | 0.366 |
| h₃ | 0.384 | 0.387 | 0.382 |
| h₄ | 0.377 | 0.379 | 0.366 |
| h₅ | 0.348 | 0.351 | 0.338 |
| h₆ | 0.387 | 0.387 | 0.377 |
| h₇ | 0.366 | 0.366 | 0.432 |
| h₈ | 0.345 | 0.335 | 0.102 |

The inventive approach assumes an agent system implemented on a highly dynamic network. In a wireless network with both mobile physical hosts and mobile agents, the network topology may change with time giving the possibility for route redundancy. Many efforts explore the complexities of wireless and mobile computing [Ioannidis et al., 1991; Watson, 1994; Forman & Zahorjan, 1994], few of these have involved mobile agents. The continuously changing nature of a wireless, ad hoc network requires considering dynamic state information [Schilit, 1995]. The practice of using the current state of the network to determine the behavior of an agent is similar to current work in active networks [Alexander et al., 1999; Murphy et al., 2001; Hicks & Keromytis, 1999; Savage et al., 1999); Tennenhouse & Wetherall, 1996]. Active network nodes are basically agent system hosts [Murphy, 1997].

Information assurance is a major goal of computer security. In agents research, there is a limited amount of literature in this area. One relevant technique deals with agent routing in the face of a security compromise [Swarup, 1997]. In contrast, the approach discussed herein, instead of focusing on what to do after a host is removed, develops a utility-based model for what to do before, and if it should be removed in the first place.

A utility-based model for agents to balance information assurance and network routing efficiency has been described herein. A natural tradeoff between information assurance and network routing efficiency for ad hoc mobile agent networks exists. Further, by empowering agents to decide for themselves how they communicate at the network level, the overall level of message integrity in an agent system can be increased. Exploitation of properties of ad hoc networks, enabling mobile agents to automatically adapt to changes that affect the security of their communication and migration has been described herein.

The capability of an agent system to dynamically reason about the state of the agent network provides new possibilities for secure computing.

Example of a MANET in Operation

This section provides a simple example of how a MANET facilitates the operation of agents in a mobile agent system.

Mobile agents have itineraries that specify which hosts to visit, and in what order. This itinerary may be the result of a planner, or some other automatic reasoning system, or it could be dynamically generated on the fly as the agent responds to network conditions. Typically, agents use an itinerary to complete its set of tasks.

The problem arises that, while an agent is performing or waiting for computations on a host, the MANET connecting the hosts may change. A change in the network may affect (1) the availability of hosts remaining in the agent's itinerary arid (2) the performance of the agent in terms of the time required to complete its tasks. For example, reaching the next host in the itinerary might require the agent traverse a very long, potentially unreliable, multi-hop, route.

The MANET publishes network state information at the agent layer so agents can sense the current situation and react accordingly. Therefore, agents have the ability to alter their itinerary using information about the network in order to adapt to any changes that may have occurred since the itinerary was created. Further, agents can improve their performance by optimizing their itinerary to fit the network state, thus completing tasks more reliably than would have been possible without intelligent routing.

Agents also can improve their level of security and information assurance. For example, if an agent visits a host that has suffered a security compromise, it also may become compromised, affecting its own data, and potentially other agents, hosts or data with which it comes in contact. In addition to adapting an itinerary for performance, the MANET allows agents to adapt for information assurance by avoiding compromised hosts as it travels in the MANET. The presence of compromised hosts, like the network itself, may change during the operation of a MANET.

Lastly, the MANET provides the underlying infrastructure for the deployment of agent-based network monitors, intrusion prevention and intrusion detection systems. Some of these agents are likely to be non-mobile, operating on data gathered by sensory agents wandering the network. When these agents (potentially an “agentized” version of an existing intrusion system) find problems, they can convey this information to the MANET and modify routing to avoid problem areas in the network.

Empirical Studies

Applying the Method

Three scenarios are given to illustrate the application of V(N) in assessing information assurance level for an agent network state. The first example uses a Vickrey auction decision procedure. The second and third examples are based on an existing and operational agent system.

An example of a decision procedure is the Vickrey auction [Vickrey, 1961] (sealed bid, second price). A Vickrey auction can be used to delegate tasks in an agent system [Brandt et al., 2000]. There is considerable research in the application of a Vickrey auction as an agent decision procedure. Given a compromised host, it is useful to know what effect that host might have on the decision procedure if it is permitted to continue in the agent system. In the case of an auction based decision procedure, the concept of “antisocial bidding” [Brandt & Weiss, 2001] can be used by agents on a compromised host to negatively affect the outcome.

A Compromised Vickrey Auction

The disclosure of bids to a compromised host can affect the intended, timely outcome of an auction. A Vickrey auction is a sealed bid auction where the second highest bid is paid by the highest bidder [Vickrey, 1961]. All bidders maximize their payoff if they employ a truthful bidding strategy. This assumes that each bidder determines its payoff solely by the difference between its valuation of an item and the price paid.

Agents often use Vickrey auctions to acquire resources. Each agent submits its bid to an auctioneer host h₁ (the sink) through the agent system's underlying network. Unless the physical host of a bidding agent is directly connected to h₁, the message containing the bid must pass through other hosts in the agent system. All agents operating under normal conditions have neither the intent nor the capability of reading bids that are routed through their physical hosts.

The first issue is that the compromised host, h_{c}, can read all bids that are sent directly to or routed by means of h_{c}. Suspicious situations in which h_{c}, alters, denies, delays or refuses to forward bids sent through itself are fairly easy to detect when one knows h_{c}, is compromised. The more subtle situation is when h_{c}, tries to corrupt the auction. In this case, instead of maximizing absolute payoff, the bidding agents on h_{c}, maximize their payoff relative to other bidding agents. In this type of “antisocial bidding” [Brandt & Weiss, 2001] an agent will attempt to maximize the difference between its profit and the profit (or losses) of other bidding agents.

Assume there are n bidding agents in the agent system. The strategy given in [Brandt & Weiss, 2001] is most successful if h_{c} knows all bids b₁, b₂, . . . , bₙ placed by all of the other bidding agents. The worst case is when all physical hosts use routes that contain h_{c}. In general this is not the case. Hence, if there are n′ hosts that use routes containing h_{c}, the probability that the highest (or any) bid is disclosed to h_{c}, is equal to n′/n.

Time is the second issue: auctioneers are not willing to wait indefinitely for all bidders to respond. In any given decision problem there is some threshold, τ, such that, if a bidder is more than τ hops from the auctioneer, its bid will not reach the auctioneer in time. Let Uᵢ be the set of all hosts that communicate with host hᵢ via a route longer than τhops:
Uᵢ={hᵢ:hⱼεH|R_{j,i}|>τ}
Uᵢ may contain hosts that use a route containing the compromised host. To adjust for this overlap, compute the set Cᵢ of hosts affected by the compromised host, but not by the required message delivery time:
C_{i={h}ⱼ:hⱼεH\hat{ }h_{c}εR_{j,i}[|R_{j,i}|≦τ}

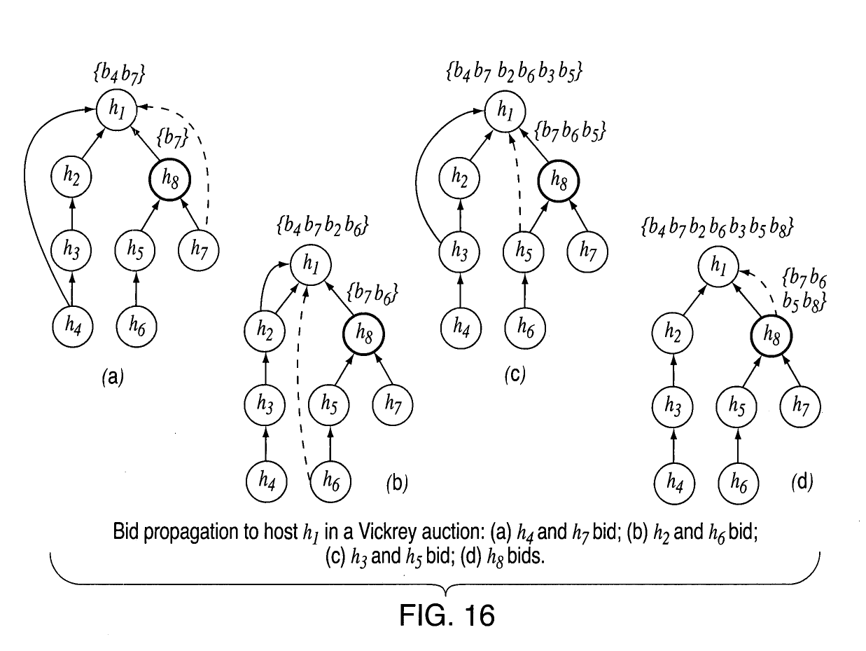

The disclosure of bids to a compromised host during this decision procedure is illustrated in FIG. 16. Assume for timing that τ=3. In this example, the probability |C₁|/n is representative of the effect of compromised messages, and the probability |U₁|/n is representative of the effect of time. As either probability increases, the value of the underlying mobile agent system should decrease.

Table 4 demonstrates how V(N) can be used to minimize the effect of a compromised host in a Vickrey auction. As the probability of compromised messages increases, the message integrity rating decreases. As the probability of unreceived messages increases, the time rating also increases. The operator yielding the highest value in this example is reroute.

TABLE 4
The terms an result of V(N) using α = 0.5, the probability of
compromises messages C₁/n, and the probability of
unreceived messages U₁/n for the result of each operator.

| Operator | \overline{m} | \overline{t} | V(N) | C₁/n | U₁/n |
|---|---|---|---|---|---|
| ignore | 0.286 | 0.250 | 0.509 | 0.5 | 0.0 |
| reroute | 0.714 | 0.321 | 0.598 | 0.25 | 0.25 |
| remove | 0.833 | 0.524 | 0.577 | 0.0 | 0.42857 |

VI. Applications
SWAT Applications
Group Display GUI

The group display GUI (graphical user interface) shows a list of all the members in a user group and allows each user to create, leave, or join a group. This process is facilitated by EMAA, which deploys encrypted agents to gather and disseminate group membership information from Secure Spread. An agent migrates from host to host, acquiring and displaying new group membership information on that host's screen. A user (typically a holder of a mobile device) has the option of creating, joining or leaving a group. However, a mobile device can only display the list of members for groups to which it belongs. The CA has its own version of the group display GUI. It shows all members for all groups. The CA monitors the network and can revoke a member by instructing the SEM to stop cooperating with that member.

SWAT “in action”

To clarify how group messaging and user revocation are achieved, a hypothetical SWAT network of 5 mobile units and two laptops is considered. The network topology in FIG. 7 is assumed.

Network Initialization

When the network is initialized, the MANET module on each device continually “cycles through” its protocol. Routing information about nearby nodes is obtained and stored in each device's routing table.

Group Kev Generation

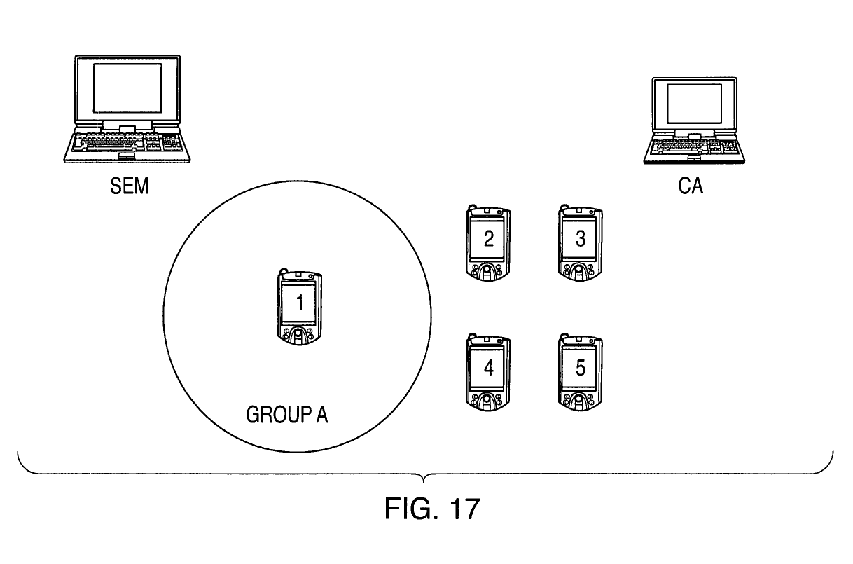

Using the group display GUI, a user with mobile unit 1 creates the group “A.” When the group display EMAA agent arrives at the EMAA dock on unit 1, it obtains this “Join” request and carries it to the CA for approval (using the routing information provided by the MANET). The agent's payload is encrypted with the CA's public key. A window appears on the CA's group display GUI informing it of the group request. The CA approves the request, and the agent migrates back to unit 1 to inform it that the CA has approved the request. Next, unit 1 engages in a contributory key agreement with one member (itself), using the CLIQUES library in Secure Spread. At the last step of key agreement, the new group structure is broadcast to the group, encrypted with each user's public key. In this case, there being only one member, unit 1 encrypts and broadcasts the group structure to itself. It receives its own message and sends the message to the SEM for partial decryption. The SEM cooperates and returns the group structure message, partially decrypted. Unit 1 decrypts the remainder of the message with its own private key, and obtains the new group structure so that it can calculate the new key. The key is calculated and made available to EMAA. The group “A” was thus created (FIG. 17).

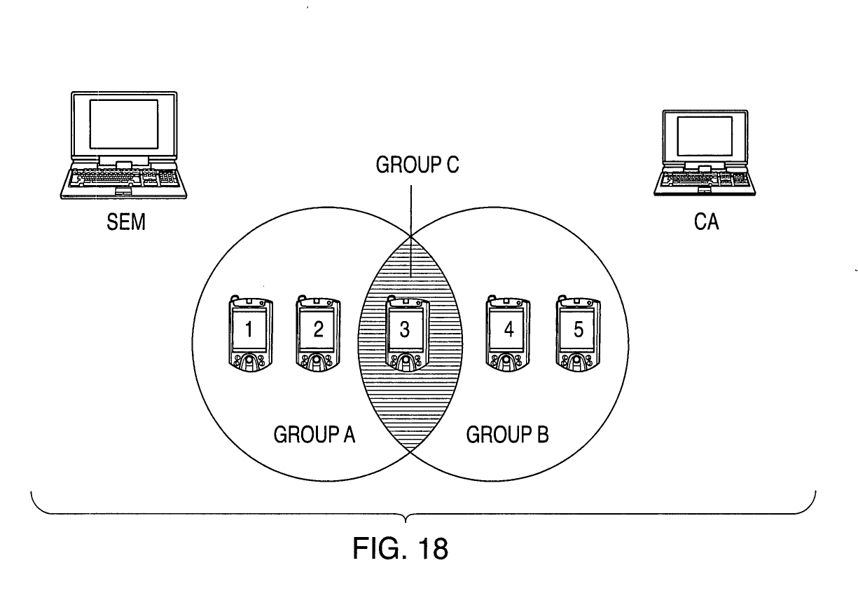

After key generation, the group display agent obtains the new group structure information from Secure Spread and disseminates it to each unit it subsequently migrates to. Every group display GUI now shows the group “A” in its listing. Unit 2 joins. A new key is generated for the members of group A (in this case, units 1 and 2). Units 1 and 2 can now make and view secure annotations on their whiteboards. Unit 3 joins group “A” and then creates a new group “B.” Units 4 and 5 join group “B” (FIG. 18). Annotations are made from unit 4, but only units 3 and 5 can see them. Annotations are made from unit 1, but only units 2 and 3 can see them.

Member Revocation

Next, a member is revoked. The CA selects unit 3 from its group display GUI and selects “revoke.” Unit 3 is now added to the SEM's revocation list. The security privileges of member 3 remain unchanged until a new key generation event occurs (e.g., a “Join” or “Leave” operation). At the last step of the key generation, when all units request partial decryption of the group key from the SEM, the SEM will refuse to aid unit 3. Thus, unit 3 will not be able to obtain the group secret key and the user cannot encrypt or decrypt any additional messages from the group. While unit 3 can neither send nor receive messages, it can still route information between other units. In this scheme the security privileges of a unit are able to be revoked but the unit retains its participation in ad-hoc routing of secure messages.

Network Topology and Resource Monitoring

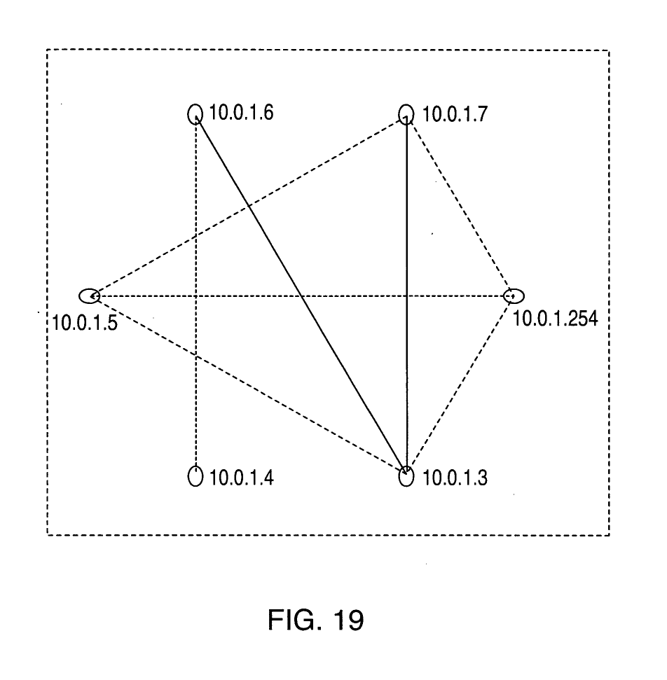

The Network Topology and Resource Monitor (FIG. 19) utilizes agents that traverse the network sampling information about each host. This sampling includes information about the state of hosts equipped with remote sensing equipment, such as cameras and GPS receivers. The topology is visually represented as an undirected graph in which each node is a host and the edges denote zero-hop routes. For example, if two hosts are within physical wireless range of each other (and therefore their communications do not require routing), an edge will be drawn between them on the graph.

Resource monitoring is used for diagnosing the state of the network and agent security. In SWAT, the resource monitoring agents report to Judge agents, which collect the resource usage data and attempt to identify suspicious hosts or traffic and report this to privileged users. In order to enable the Judge agents to make these decisions, SWAT imposes a structure upon the data collected by the resource monitoring agents. One technique SWAT uses is rule-based, in which information obtained by the agents is used to generate rules which update a knowledge base maintained at the target Judge agent. In the present SWAT, Judge agents use a previously created static decision tree to determine the appropriate actions given the current state of the network (i.e., revocation of group membership, removal of a host from the network, etc). SWAT may use more sophisticated machine learning techniques to allow Judge agents to perform host and agent profiling.

Meta-Reasoning for Information Assurance

Network meta-reasoning agents use a state description of SWAT's underlying ad hoc network to reason about how agents communicate. Based on this state description, a formal representation of information assurance for agent messaging is used to evaluate the agent system's state with regard to a compromised host. For example, as Judge agents detect an intrusion, the network meta-reasoning agents determine what action (if any) should be taken against that intrusion. Possible actions include, but are not limited to, ignoring the compromised host, rerouting the network around the compromised host where possible and removing the compromised host completely from the network. The utility of an action is found by quantifying the effect of the compromised host on the integrity of messages among agents. Agents can determine, in real time, what action will provide the best balance of message integrity and routing efficiency.

The present invention may be embodied in other specific forms without departing from the spirit or essential attributes thereof and, accordingly, reference should be made to the appended claims, rather than to the foregoing specification, as indicating the scope of the invention.

1. A method of developing and deploying an application or communication on a computer network comprising:
building a key through use of a contributory group key generating algorithm in conjunction with a key agreement protocol;
employing a messaging system for running the key agreement protocol;
using a mechanism for revoking the key from an agent, user, group, network or host.

2. The method of claim 1, wherein the contributory group key generating algorithm comprises at least one of GDH and TGDH.

3. The method of claim 1, wherein the key agreement protocol comprises CLIQUES.

4. The method of claim 1, wherein the messaging system comprises at least one of Spread and Secure Spread.

5. The method of claim 1, wherein the mechanism for revoking the key comprises a SEM.

6. The method of claim 1, further comprising assigning the key to an agent, user, group, network or host.

7. The method of claim 1, wherein the computer network comprises a mobile computer network.

8. A system for developing and deploying an application or communication on a computer network comprising:
a contributory group key generating algorithm in conjunction with a key agreement protocol for building a key;
a messaging system for running the key agreement protocol;
a mechanism for revoking the key from an agent, user, group, network or host.

9. The system of claim 8, wherein the contributory group key generating algorithm comprises at least one of GDH and TGDH.

10. The system of claim 8, wherein the key agreement protocol comprises CLIQUES.

11. The system of claim 8, wherein the messaging system comprises at least one of Spread and Secure Spread.

12. The system of claim 8, wherein the mechanism for revoking the key comprises a SEM.

13. The system of claim 8, further comprising a mechanism for assigning the key to an agent, user, group, network or host.

14. The system of claim 8, wherein the computer network comprises a mobile computer network.

15. A system for developing and deploying a distributed application or communication on a dynamically changing computer network comprising:
a mechanism for deploying a mobile software agent with a rate of migration on at least one network; and
a mobile node.

16. The system of claim 15, wherein the mobile node acts as a temporary holder of software code.

17. The system of claim 16, wherein the mobile agent is capable of migrating between mobile nodes.

18. The system of claim 15, wherein the application or communication on the network is built using a mobile agent.

19. The system of claim 18, wherein the application or communication built using the mobile agent is capable of adapting to changing network and security conditions.

20. The system of claim 15, wherein the mobile agent is network- and security-aware.

21. The system of claim 15, further comprising a mechanism for building a collaborative application or communication using at least one mobile software agent.

22. The system of claim 21, wherein the collaborative application or communication is fault-tolerant and distributed.

23. The system of claim 22, wherein the collaborative application or communication does not require a central server.

24. The system of claim 22, wherein a state of the collaborative application or communication is stored on the network.

25. The system of claim 22, wherein the collaborative application or communication implements at least one of audio and video streaming.

26. The system of claim 22, wherein the collaborative application or communication implements a method of displaying a map.

27. The system of claim 16, further comprising a mechanism for generating a symmetric encryption key for a logical group of computer nodes, agents, hosts or users on the network.

28. The system of claim 27, wherein each agent, host, user or network node in the logical group is responsible for participating in the mechanism for generating the symmetric encryption key.

29. The system of claim 27, further comprising a mechanism for protecting a mobile host from a mobile software agent.

30. The system of claim 29, wherein the mobile software agent is encrypted using the encryption key.

31. The system of claim 15, wherein the mobile agent is capable of being a member of a logical group.

32. The system of claim 15, further comprising a mechanism for enabling communication with a low-power sensor network.

33. The system of claim 15, further comprising a deployed data logging sensor field capable of being downloaded using a pull protocol.

34. The system of claim 15, further comprising of a mechanism for disseminating Global Position System data via at least one mobile agent.

35. The system of claim 34, wherein the disseminated Global Position System data is displayed on a collaborative application built using at least one mobile agent.

36. The system of claim 34, wherein the disseminated Global Position System data is secured using an encrypted key.

37. The system of claim 18, further comprising a mechanism for revoking an agent, user, group, network or host from participating in a group generation process.

38. The system of claim 15, further comprising of a mechanism for modeling system performance.

39. The system of claim 38, wherein the mechanism for modeling system performance comprises battery profiling.

40. The system of claim 15, further comprising a mechanism for providing a centralized view of the network or network topology.

41. The system of claim 40, wherein a user can see the centralized view of the network or network topology.

42. The system of claim 41, wherein a cryptographic logical group structure of the network is capable of being changed by the user.

43. The system of claim 15, wherein the computer network comprises a mobile computer network.

44. A method for developing and deploying a distributed application or communication on a dynamically changing computer network comprising:
deploying a mobile software agent with a rate of migration on at least one network; and
temporarily holding software code in a mobile node.

45. The method of claim 44, wherein the mobile agent is capable of migrating between mobile nodes.

46. The method of claim 44, further comprising building the application or communication on the network with a mobile agent.

47. The method of claim 46, wherein the application or communication built using the mobile agent is capable of adapting to changing network and security conditions.

48. The method of claim 44, wherein the mobile agent is network- and security-aware.

49. The method of claim 44, further comprising building a collaborative application or communication using at least one mobile software agent.

50. The method of claim 49, wherein the collaborative application or communication is fault-tolerant and distributed.

51. The method of claim 50, wherein the collaborative application or communication does not require a central server.

52. The method of claim 50, wherein a state of the collaborative application or communication is stored on the network.

53. The method of claim 51, further comprising implementing at least one of audio and video streaming in the collaborative application or communication.

54. The method of claim 51, further comprising implementing a method of displaying a map in the collaborative application or communication.

55. The method of claim 44, further comprising generating a symmetric encryption key for a logical group of computer nodes, agents, hosts or users on the network.

56. The method of claim 55, wherein each agent, host, user or network node in the logical group is responsible for participating in the mechanism for generating the symmetric encryption key.

57. The system of claim 55, further comprising protecting a mobile host from a mobile software agent.

58. The method of claim 57, further comprising encrypting the mobile software agent through use of the encryption key.

59. The method of claim 44, wherein the mobile agent is capable of being a member of a logical group.

60. The method of claim 44, further comprising enabling communication with a low-power sensor network.

61. The method of claim 44, further comprising downloading a deployed data logging sensor field through use of a pull protocol.

62. The method of claim 44, further comprising disseminating Global Position System data via at least one mobile agent.

63. The method of claim 62, further comprising displaying the disseminated Global Position System data on a collaborative application built using at least one mobile agent.

64. The method of claim 62, further comprising securing the disseminated Global Position System data through use of an encrypted key.

65. The method of claim 46, further comprising revoking an agent, user, group, network or host from participating in a group generation process.

66. The method of claim 44, further comprising modeling system performance.

67. The method of claim 66, wherein modeling system performance comprises battery profiling.

68. The method of claim 44, further comprising providing a centralized view of the network or network topology.

69. The method of claim 68, further comprising displaying the centralized view of the network or network topology.

70. The method of claim 44, further comprising changing a cryptographic logical group structure of the network.

71. The method of claim 44, wherein the computer network comprises a mobile computer network.
